(19) United States
(12) Patent Application Publication
(10) Pub. No.: US 2026/0361951 A1
(43) Pub. Date: Nov. 12, 2026

(54) DYNAMICALLY INSERTING AUXILIARY MEDIA CONTENT INTO LIVE MEDIA STREAMS

(71) Applicant: NETFLIX, INC., Los Gatos, CA (US)

(72) Inventors: Mark WATSON, San Francisco, CA (US); Simon Lloyd SPENCER, Sunnyvale, CA (US); Andrew John SWEENEY, Brooklyn, NY (US); Aartee SABHARWAL, Torrance, CA (US); Adam LEVY, New York, NY (US); Johan HENKENS, Bear Valley, CA (US)

(21) Appl. No.: 19/406,806

(22) Filed: Dec. 2, 2025

Related U.S. Application Data
(60) Provisional application No. 63/801,720, filed on May 7, 2025.

(51) Int. Cl. H04N 21/44; G06F 40/205; H04N 21/2187; H04N 21/231

(52) U.S. Cl. CPC H04N 21/44016; G06F 40/205; H04N 21/2187; H04N 21/23106

(57) ABSTRACT

In various embodiments, a computer-implemented method for prefetching auxiliary media content information associated with an upcoming auxiliary media content break when streaming primary audiovisual content associated with media titles includes determining that a prefetch window has been reached during streaming of the primary audiovisual content, determining a prefetch time within the prefetch window based on at least one parameter, prefetching, at the prefetch time, the auxiliary media content information, and causing auxiliary media content to be played during the upcoming auxiliary media content break based at least on the auxiliary media content information.

### CROSS-REFERENCE TO RELATED APPLICATIONS

This application claims the benefit of U.S. Provisional Application titled “TECHNIQUES FOR DYNAMICALLY INSERTING ADVERTISEMENTS INTO LIVE MEDIA STREAMS,” filed on May 7, 2025, and having Serial No. 63/801,720. The subject matter of this related application is hereby incorporated herein by reference.

### BACKGROUND

### Field of the Various Embodiments

Embodiments of the present disclosure relate generally to computer science and video processing and, more specifically, to dynamically inserting auxiliary media content into live media streams.

### Description of the Related Art

Modern streaming services typically implement cloud-based networks of computer systems to stream audiovisual content associated with media titles to endpoint devices. The media titles can be pre-recorded in advance or correspond to live events occurring in real time. An architecture of a given cloud-based network often includes one or more content sources, one or more encoding pipelines, one or more packagers, one or more origin servers, and a content delivery network (CDN). In such an architecture, the content sources produce raw audiovisual content and distribute that content to the encoding pipelines. The encoding pipelines encode the raw audiovisual content into a compressed format and transmit encoded audiovisual content to the packagers. The packagers prepare the encoded audiovisual content for playback on various downstream endpoint devices and provide the packaged audiovisual content to the origin servers. The origin servers store the packaged audiovisual content and distribute that content to the CDN. The CDN includes a hierarchy of geographically distributed CDN nodes that distribute the content to nearby endpoint devices. A given endpoint device can decode the received audiovisual content and then output the decoded audiovisual content for display to a user.

The architecture described above can support many different streaming configurations. In a streaming video on demand (SVOD) configuration, audiovisual content corresponding to a given media title is pre-recorded and stored by the content sources prior to encoding, packaging, and subsequent distribution to the endpoint devices. In a live streaming configuration, audiovisual content associated with a media title is recorded in real time at a broadcast location where a live event is occurring and then subsequently encoded, packaged, and distributed to endpoint devices for real-time playback. Under any streaming configuration, advertisements can be seamlessly spliced into the primary audiovisual content associated with a given media title by inserting ad markers into a timed metadata track and configuring the markers to indicate the locations of specific frames where the insertion of advertisements should occur. However, various technical issues arise when inserting advertisements into media titles corresponding to live events.

In particular, during the streaming of live events, producers of those events sometimes prefer that ads be shown to each user at the same point in playback of the live event. For example, during popular events such as the Super Bowl, ads are generally perceived as an important collective experience to be shared between viewers. Consequently, when an ad break occurs during the live event, a large multitude of endpoint devices need to retrieve the same ad payloads from an ad server at the same time. Under these conditions, the ad server can easily become overwhelmed and shut down. A similar problem can arise even when different endpoint devices retrieve different ad payloads, because during live events a large multitude of endpoint devices often need to access the ad server to retrieve ad information during a coordinated break in the live action.

In addition, during many types of live events, the timing of ad breaks, and the specific ads that will be shown during those ad breaks, is often unpredictable. For example, during American football games, different types of ad breaks can be triggered manually at the broadcast studio in response to unpredictable real-world occurrences, such as time-outs or injury breaks, that often occur without warning. Under these conditions, a large multitude of endpoint devices need to retrieve the same ad information from the ad server at the same time, potentially causing the ad server to become overwhelmed and fail to return ad payload.

In addition, the duration of ad breaks can remain unpredictable because there is often a need to return to the live stream earlier than expected. For example, during a live event, an ad break might conclude unpredictably whenever a sporting event resumes earlier than anticipated following an injury break. In another example, an ad break might end prematurely if initiated due to human or technical error. Playback of an ad during an ad break might also fail, thereby resulting in the endpoint device lacking sufficient content to effectively playback relevant content during the ad break. Accordingly, in any of these early return scenarios, significant challenges arise in rejoining the endpoint device with a live stream.

Additionally, users who join a live stream at different times can experience inconsistent ad experiences, particularly when advertisements are dynamically inserted into the live stream. For example, some users can join a live stream corresponding to a live event as the broadcast occurs, which is referred to herein as a viewer or an endpoint device viewing the streaming media content at the live edge. Alternatively, other users might join the broadcast from the beginning after an event has already begun. Such users are therefore viewing the broadcast under a delay or behind the live edge. Regardless of when a user joins a broadcast via an endpoint device, although advertisements can be dynamically inserted into a stream provided to a particular user, a consistent user experience is desired. This ensures that a user at the live edge and one behind the live edge receive the same ad experience. In some cases, the flexibility to offer a personalized experience to users streaming a media title at the live edge or behind the live edge is desired. Accordingly, with a conventional dynamic ad insertion system, providing a consistent ad experience to users who are at the live edge and users behind the live edge is difficult or impossible because the system cannot determine which ads were shown to users at the live edge and when such ads were shown during the live stream.

As the foregoing illustrates, what is needed in the art is a more effective technique for inserting advertisements into live media streams.

### SUMMARY

In various embodiments, a computer-implemented method for prefetching auxiliary audiovisual content information associated with an upcoming auxiliary audiovisual content breaks when streaming primary audiovisual content associated with a media title includes determining that a prefetch window has been reached during streaming of the primary audiovisual content, determining a prefetch time within the prefetch window based on at least one parameter, prefetching, at the prefetch time, auxiliary audiovisual content information associated with an upcoming auxiliary audiovisual content break, and playing auxiliary audiovisual content during the upcoming auxiliary audiovisual content break based on the auxiliary audiovisual content information.

In various embodiments, an endpoint device determines the prefetch time within the prefetch window. In various other embodiments, the endpoint device receives the prefetch time from a server. The auxiliary audiovisual content information can include, for example and without limitation, auxiliary audiovisual content decisions indicating specific portions of auxiliary audiovisual content to be played, metadata describing attributes of different portions of auxiliary audiovisual content, and/or auxiliary audiovisual content manifests describing playback information associated with one or more portions of auxiliary audiovisual content. The disclosed techniques can be applied to various situations where streaming of primary audiovisual content is interrupted temporarily in order to stream auxiliary audiovisual content, including, but not limited to, situations where a live stream is temporarily interrupted in order to play one or more advertisements (ads).

In various embodiments, In various embodiments, a computer-implemented method for computer-implemented method playback of auxiliary media content associated with auxiliary media content breaks when streaming media content, the method including identifying an upcoming auxiliary media content break based on auxiliary media content information prefetched prior to the auxiliary media content break, terminating playback of streaming media content at a specified time based on the auxiliary media content information, playing back one or more auxiliary media content items specified by the ad information, receiving a second indication that the auxiliary media content break is ending at an unexpected time, the unexpected time being prior to a scheduled time, determining a playback resumption point based on the second indication and the one or more auxiliary media content items, and resuming playback of the streaming media content at the playback resumption point.

In various embodiments, a computer-implemented method for playback of auxiliary media content associated with auxiliary media content breaks when streaming media content including transmitting a request for an auxiliary media content break history associated with streaming media content, determining, based on a prefetched identifier in the auxiliary media content break history, that an auxiliary media content break associated with the streaming media content is commencing, retrieving an identification of auxiliary media content items associated with the auxiliary media content break based on the prefetched identifier, retrieving a first manifest corresponding to a first auxiliary media content item specified by the identification of auxiliary media content items, requesting a first media file associated with the first auxiliary media content items based on the first manifest, and playing the first media file associated with the first auxiliary media content item.

At least one technical advantage of the disclosed techniques relative to the prior art is that the disclosed techniques enable endpoint devices to distribute requests for ad information across a time interval. Such an approach minimizes large traffic spikes and prevents an ad manager from becoming overwhelmed when servicing those requests. Another technical advantage of the disclosed techniques is that the disclosed techniques enable endpoint devices to prefetch ad information for multiple alternative ad breaks. In one embodiment, an endpoint device can selectively refrain from prefetching at least some ad information in order to minimize server load. Such an approach minimizes large traffic spikes or missed ad impressions that can occur in response to unforeseen ad breaks, and further protects the ad manager from becoming overwhelmed when servicing requests for ad information.

At least one technical advantage of the disclosed techniques relative to the prior art is that the disclosed techniques enable endpoint devices to rejoin a live stream without the viewer missing any content at the live edge. The disclosed techniques identify a splice point at which playback of an ad or an ad break can be terminated and at which playback of streaming media content can be resumed. Such an approach results in a smoother playback experience for the user because the frames corresponding to the ad and the frames corresponding to the streaming media content are not dropped or missed. Additionally, when the endpoint device is behind the live edge due to resuming playback of the streaming media content behind the live edge, the disclosed techniques can utilize various measures to catch up the endpoint device to the live edge.

Another technical advantage of the disclosed techniques relative to the prior art is that the disclosed techniques enable endpoint devices to receive a consistent ad experience regardless of whether the respective endpoint devices join streaming media content corresponding to a live event at the live edge or before the live edge. Such an approach also minimizes traffic spikes and prevents the ad manager from becoming overwhelmed when servicing requests for ad information from various endpoint devices that are receiving the streaming media content. Yet another technical advantage of the disclosed techniques is that the disclosed techniques enable endpoint devices to be served the same or varying ad experiences based on where the respective endpoint devices join a respective stream.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates a network infrastructure that can be used to distribute audiovisual content to the endpoint devices of FIG. 1, according to various embodiments;

FIG. 6 is a sequence diagram of various operations an endpoint device performs to play ads during live streaming, according to various embodiments;

FIGS. 7A-7B illustrate how endpoint devices distribute requests for ad information across a prefetch window during live streaming, according to various embodiments;

FIG. 8 is flow diagram of method steps for prefetching ad information during live streaming, according to various embodiments;

FIGS. 9A-9B illustrate how endpoint devices prefetch ad information associated with alternative possible ad breaks during live streaming, according to various embodiments; and

FIG. 10 is a flow diagram of method steps for prefetching alternative ad information during live streaming, according to various embodiments;

FIGS. 11A-11B illustrate how endpoint devices handle a scenario in which an ad break ends prematurely or unexpectedly and returns to the streaming media content, according to various embodiments;

FIG. 12 is a flow diagram of method steps for handling early return scenarios, according to various embodiments;

FIG. 13 illustrates how endpoint devices handle a scenario in which the endpoint device is streaming media content behind the live edge, according to various embodiments; and

FIG. 14 is a flow diagram of method steps for obtaining ad decisions when streaming media content behind the live edge, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Various technical issues arise when inserting advertisements into media titles corresponding to live events. In particular, during the streaming of live events, producers of those events generally prefer that the same ads be shown to each user at the same point in playback of the live event. For example, during popular events such as the Super Bowl, ads are generally perceived as an important collective experience to be shared between viewers. Consequently, when an ad break occurs during the live event, a large multitude of endpoint devices need to retrieve the same ad information from an ad server at the same time. Under these conditions, the ad server can easily become overwhelmed and shut down. In addition, during many types of live events, the timing of ad breaks, and the specific ads that will be shown during those ad breaks, is often unpredictable. For example, during American football games, different types of ad breaks can be triggered manually at the broadcast studio in response to unpredictable real-world occurrences, such as time-outs or injury breaks, that often occur without warning. Under these conditions, a large multitude of endpoint devices need to retrieve the same ad information from the ad server at the same time, potentially causing the ad server to become overwhelmed and shut down.

In addition, the duration of ad breaks can remain unpredictable because often there is a need to return to the live stream earlier than expected. For example, during a live event, an ad break might conclude unpredictably whenever a sporting event resumes earlier than anticipated following an injury break. In another example, an ad break might end prematurely if initiated due to human or technical error. In yet another example, playback of an ad during an ad break might fail. This can result in the endpoint device lacking sufficient content to effectively show relevant content during the ad break. Accordingly, in any of these early return scenarios, significant challenges arise in rejoining the endpoint device with a live stream.

In some scenarios, when an endpoint device joins a broadcast of a live event at the live edge, ad breaks might prematurely or unexpectedly end so that the broadcast of the live event returns from an ad break earlier than expected. For example, if a time-out or injury break ends earlier than expected, the ad break can end earlier than expected, resulting in the live event resuming. In the case of an early return from an ad break, the viewer might miss some portion of the live event. Alternatively, the early return from the ad break might result in a viewing experience that is inconsistent or choppy if the resumption of the live event is not performed elegantly. In some cases, playback of one or more ads in the ad break might fail, resulting in insufficient content for playback during the ad break.

In another scenario, users who join a live stream at different times can be presented with inconsistent ad experiences, particularly when advertisements are dynamically inserted into the live stream. For example, some users can join a live stream corresponding to a live event as the broadcast occurs, which is referred to herein as a viewer or an endpoint device viewing the streaming media content at the live edge. Alternatively, other users might join the broadcast from the beginning after an event has already begun. Such users are therefore viewing the broadcast under a delay or behind the live edge. Regardless of when a user joins a broadcast via an endpoint device, even though advertisements can be dynamically inserted into a stream provided to a particular user, a consistent user experience is desired. This ensures that a user at the live edge and one behind the live edge receive the same ad experience. In some cases, the flexibility to offer a personalized experience to users streaming media content at the live edge or behind the live edge is desired. Accordingly, with a conventional dynamic ad insertion system, providing a consistent ad experience to different users is difficult or impossible because the system cannot determine which ads were presented.

To address these issues, an endpoint device is configured to stream primary audiovisual content associated with media titles corresponding to a live event occurring in real time. During live streaming, the endpoint device can transition from streaming the primary audiovisual content to streaming auxiliary content associated with one or more advertisements (ads) during a pre-planned or spontaneous ad break. The endpoint device streams the primary audiovisual content using a playback manifest that describes how and where to obtain such primary audiovisual content. The playback manifest also describes a prefetch window within which the endpoint device can prefetch ad information associated with an upcoming ad break.

When the prefetch window arrives, the endpoint device computes a prefetch time at which to prefetch various ad information. The prefetch time can be computed randomly or selected based on various operational attributes of the endpoint device and/or other portions of network infrastructure. For example, in one embodiment, the prefetch time can be determined based on network bandwidth. When the prefetch time arrives, the endpoint device prefetches ad decisions that describe specific ads that should play during the ad break. Based on the ad decisions, the endpoint device then prefetches one or more ad manifests that describe how and where to obtain audiovisual content associated with the corresponding ads. When the ad break commences, the endpoint device plays the relevant ads using the relevant ad manifests, and then fetches additional ad manifests as needed based on an amount of available memory resources. In some cases, the endpoint device prefetches ad information, including ad decisions and ad manifests, associated with multiple alternative ad breaks that could be selected to commence. Upon receipt of an ad marker indicating a specific selection of ad break, the endpoint device may discard any unneeded ad manifests and fetch additional ad manifests associated with the selected ad break. When the ad break arrives a short time later, the endpoint device is already prepared to play at least the first ad based on the prefetched ad manifests. Further ad manifests may be fetched during the break as needed, with each manifest fetched at a random time during playback of the preceding ads in order to avoid overloading a backend server that stores ad manifests.

Once an ad break commences and the endpoint device terminates playback of a streaming media title to begin playback of the relevant ads for which the ad manifests were prefetched, a risk exists that the ad break might end prematurely or unexpectedly. Accordingly, the endpoint device can handle an early return to streaming the primary audiovisual content upon receiving a digital marker that indicates the ad break has been cancelled or is ending earlier than expected. However, multiple scenarios exist for which the endpoint device should account. For example, in one scenario, the endpoint device streams a live event at the live edge. In such a scenario, the endpoint device determines a playback resumption point at which the ad break can be ended and playback of the streaming media title, corresponding to the live event, resumes. In some instances, even if an endpoint device is streaming the live event at the live edge, an early return to the live event can result in the endpoint device returning to the live event slightly behind the live edge. Accordingly, the endpoint device can allow the stream to remain slightly behind the live edge or implement one or more measures to catch up to the live edge. In another scenario, the endpoint device streams the live event behind the live edge. In such a scenario, the endpoint device determines a playback resumption point at which the ad break can be terminated and playback of the streaming media title corresponding to the live event can be resumed. In the context of this disclosure, ads are also referred to as auxiliary media content or auxiliary media content items and ad breaks are also referred to as auxiliary media content breaks.

At least one technical advantage of the disclosed techniques relative to the prior art is that the disclosed techniques enable endpoint devices to distribute requests for ad information across a time interval. Such an approach minimizes large traffic spikes and prevents an ad manager from becoming overwhelmed when servicing those requests. Another technical advantage of the disclosed techniques is that the disclosed techniques enable endpoint devices to prefetch ad information for multiple alternative ad breaks. In one embodiment, an endpoint device can selectively refrain from prefetching at least some ad information in order to minimize server load and/or play one or more ads embedded in the live stream (potentially on a per-country basis) in lieu of dynamically fetching one or more ads. Such an approach minimizes large traffic spikes or missed ad impression or personalization opportunities that can occur in response to unforeseen ad breaks, and further protects the ad manager from becoming overwhelmed when servicing requests for ad information.

At least one technical advantage of the disclosed techniques relative to the prior art is that the disclosed techniques enable endpoint devices to rejoin a live stream without the viewer missing any content at the live edge. The disclosed techniques identify a splice point at which playback of an ad or an ad break can be terminated and at which playback of a streaming media title can be resumed. Such an approach results in a smoother playback experience for the user because frames corresponding to the ad and frames corresponding to the streaming media title are not missed. Furthermore, when the endpoint device is behind the live edge due to resuming playback of the streaming media title behind the live edge, the disclosed techniques can implement various measures to catch up the endpoint device to the live edge.

Another technical advantage of the disclosed techniques relative to the prior art is that the disclosed techniques enable endpoint devices to receive a consistent ad experience regardless of whether respective endpoint devices are joining a streaming media title at the live edge or before the live edge. Such an approach also minimizes traffic spikes and prevents the ad manager from becoming overwhelmed when servicing requests for ad information from various endpoint devices that are receiving a streaming media title. Yet another technical advantage of the disclosed techniques is that the disclosed techniques enable endpoint devices to be served the same or varying ad experiences based on where respective endpoint devices join a respective stream.

These technical advantages provide one or more technological advancements over prior art approaches.

Although the various technical issues mentioned above are described in the context of advertising, persons skilled in the art will understand how these same technical issues can arise when temporarily suspending or stopping playback of primary audiovisual content associated with a media title and then diverting playback to auxiliary audiovisual content. The auxiliary media content could include any technically feasible form of messaging, announcements, intermission content, diagnostic or status information, service data, and so forth, for example and without limitation.

### System Overview

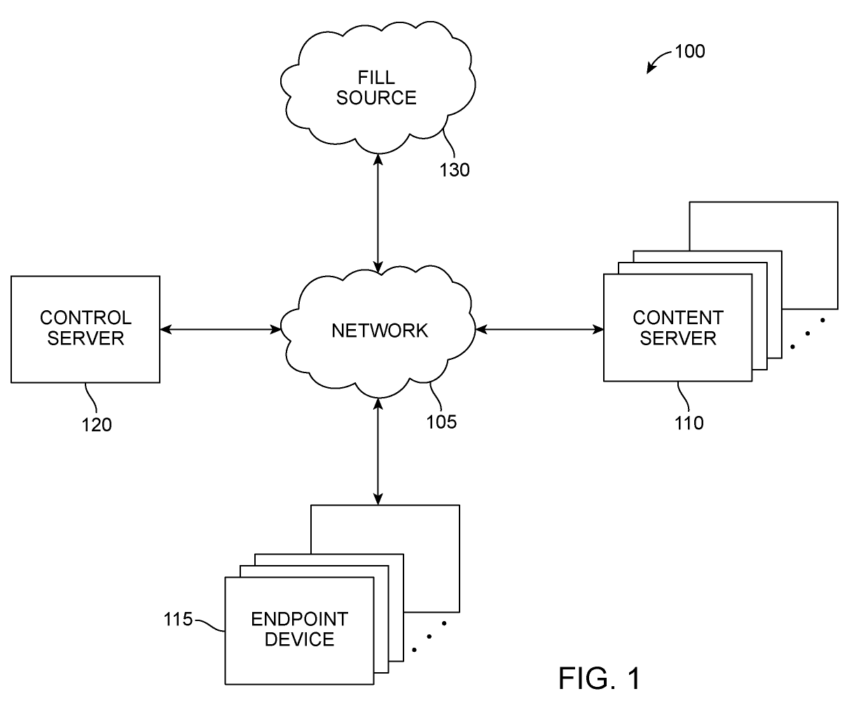

FIG. 1 illustrates a system 100 used to distribute content to content servers 110 and endpoint devices 115, according to various embodiments. As shown, the system 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

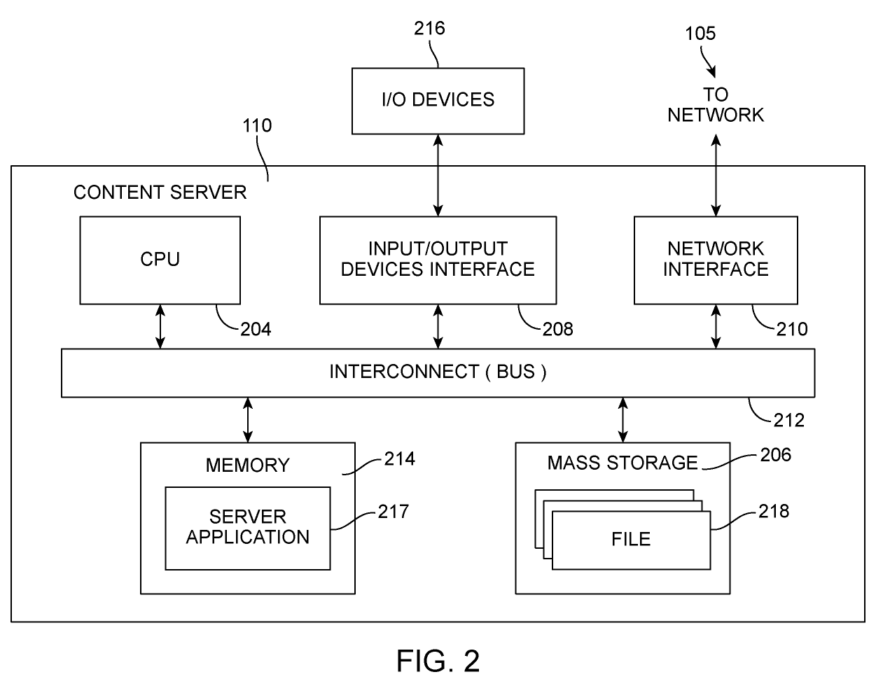

FIG. 2 is a block diagram of a content server 110 that may be implemented in conjunction with the system 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

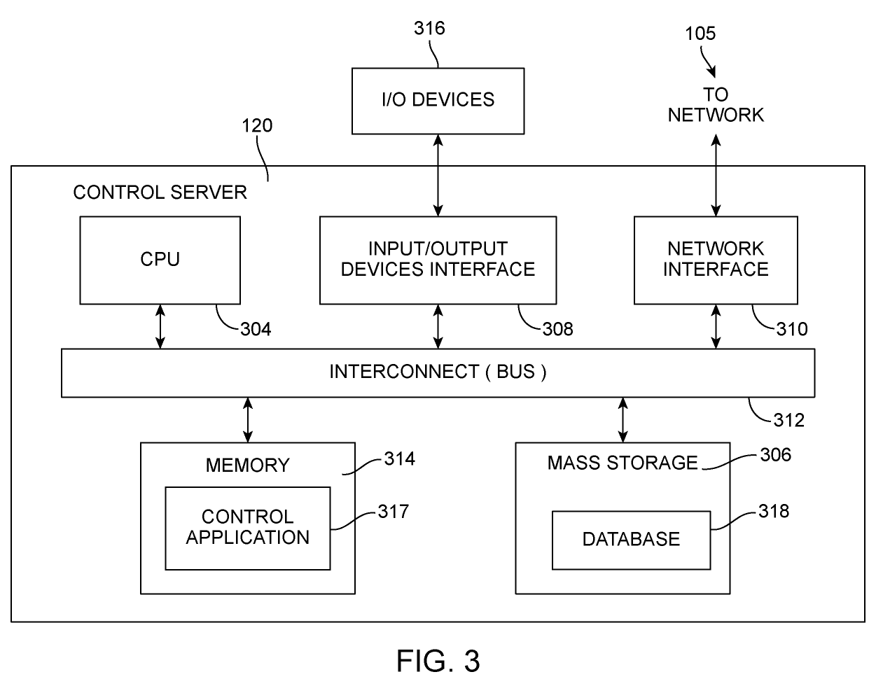

FIG. 3 is a block diagram of a control server 120 that may be implemented in conjunction with the system 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the system 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

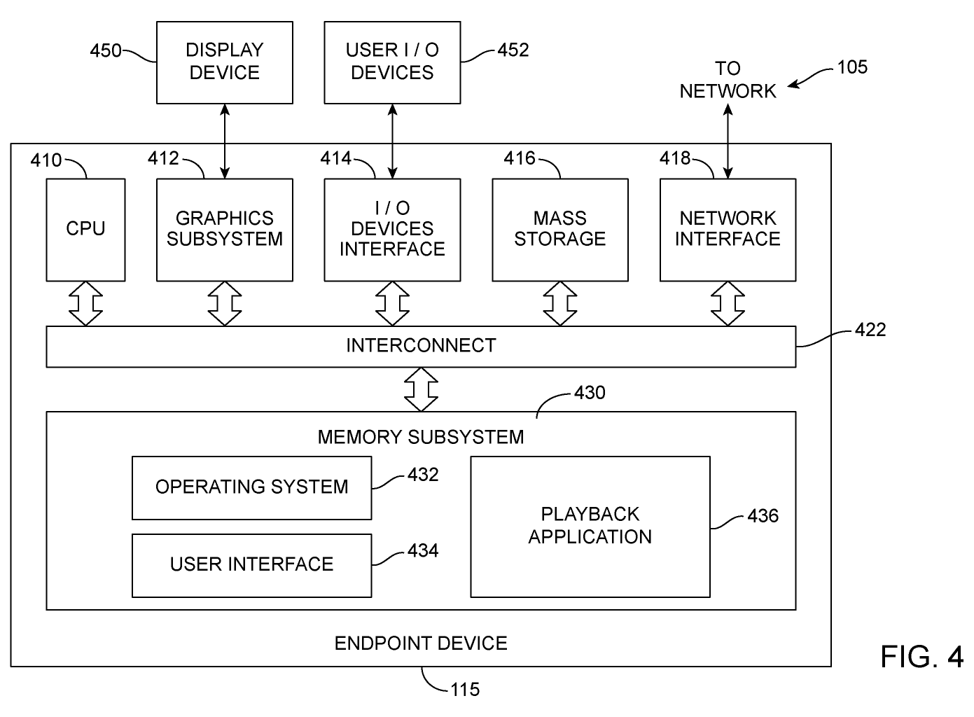

FIG. 4 is a block diagram of an endpoint device 115 that may be implemented in conjunction with the system 100 of FIG. 1, according to various embodiments of the present invention. As shown, endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Dynamically Inserting Advertisements Into Live Media Streams

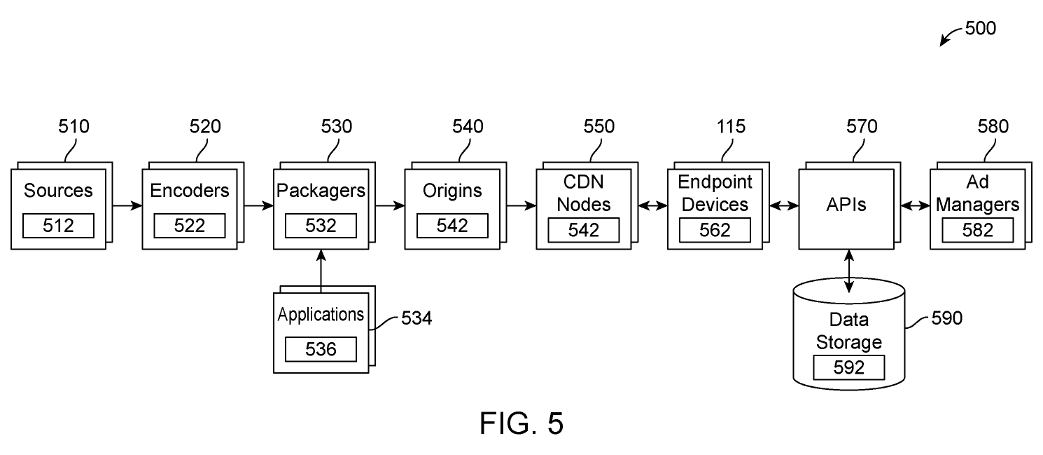

FIG. 5 illustrates a network infrastructure 500 that can be used to distribute audiovisual content to the endpoint devices of FIG. 1, according to various embodiments. As shown, the network infrastructure 500 includes one or more sources 510, one or more encoders 520, one or more packagers 530, one or more origins 540, one or more content delivery network (CDN) nodes 550, one or more endpoint devices 115, one or more application programming interfaces (APIs) 570, one or more advertisement (ad) managers 580, and data storage 590. The network infrastructure 500 is configured to generate, process, and distribute segments of audiovisual content to endpoint devices 115, where a given segment of audiovisual content includes one or more frames of audio data and/or video data.

The network infrastructure 500 may form any technically feasible portion of, or extension to, the system 100 shown in FIG. 1. Further, various components of the network infrastructure 500 can be implemented via the different components of the system 100 described above in conjunction with FIGS. 1-4. In particular, in various embodiments, origins 540 may be implemented via one or more fill sources 130, and/or CDN nodes 550 may be implemented via one or more content servers 110. Various components of the system 100 and/or network infrastructure 500 may form a portion of a control plane, such as the control server 120, for example and without limitation, while other components of the system 100 or network infrastructure 500 may form a portion of a data plane, such as the origins 540, for example and without limitation.

In operation, the network infrastructure 500 processes audiovisual content when streaming media titles to endpoint devices 115. A given media title can be pre-recorded or, alternatively, can correspond to a live event occurring in real time. Accordingly, the network infrastructure 500 can support both streaming video on demand (SVOD) configurations as well as live streaming configurations. In an SVOD configuration, audiovisual content corresponding to a given media title is pre-recorded and stored by the sources 510 prior to encoding, packaging, and subsequent distribution to the endpoint devices 115. In a live streaming configuration, audiovisual content associated with a media title is recorded in real time at a broadcast location where a live event is occurring and then subsequently encoded, packaged, and distributed to endpoint devices for real-time playback. In this configuration, a given source 510 generally corresponds to a control center associated with the broadcast location that coordinates the production of audiovisual content at the broadcast location.

In either of the above-described streaming configurations, the sources 510 distribute raw frames 512 of audiovisual content to the encoders 520. Upon receipt of the raw frames 512 of audiovisual content, the encoders 520 encode the raw frames of audiovisual content into encoded frames 522 of audiovisual content and provide these encoded frames 522 to the packagers 530 via one or more encoded video streams. The packagers 530 perform various packaging operations to prepare the encoded frames 522 for downstream decoding and output by endpoint devices 115, thereby generating packaged frames 532 of audiovisual content. The packagers 530 transmit the packaged frames 532 to origins 540, which provide location-based storage of packaged frames 532 as compressed objects 542. The origins 540 distribute the compressed objects 542 to the CDN nodes 550. The CDN nodes 550 reside within a global CDN network and are geographically distributed at edge locations proximate to different endpoint devices 115. The CDN nodes 550 are configured to store cached objects 552 representing different copies of compressed objects 542. Upon request, one or more CDN nodes 550 transmit one or more cached objects 552 to endpoint devices 115 in order to support the streaming of media titles. A given endpoint device 115 performs a decoding operation with the received object(s) to generate decoded frames 562 of audiovisual content. Decoded frames 562 of audiovisual content can then be output to the user via a display device.

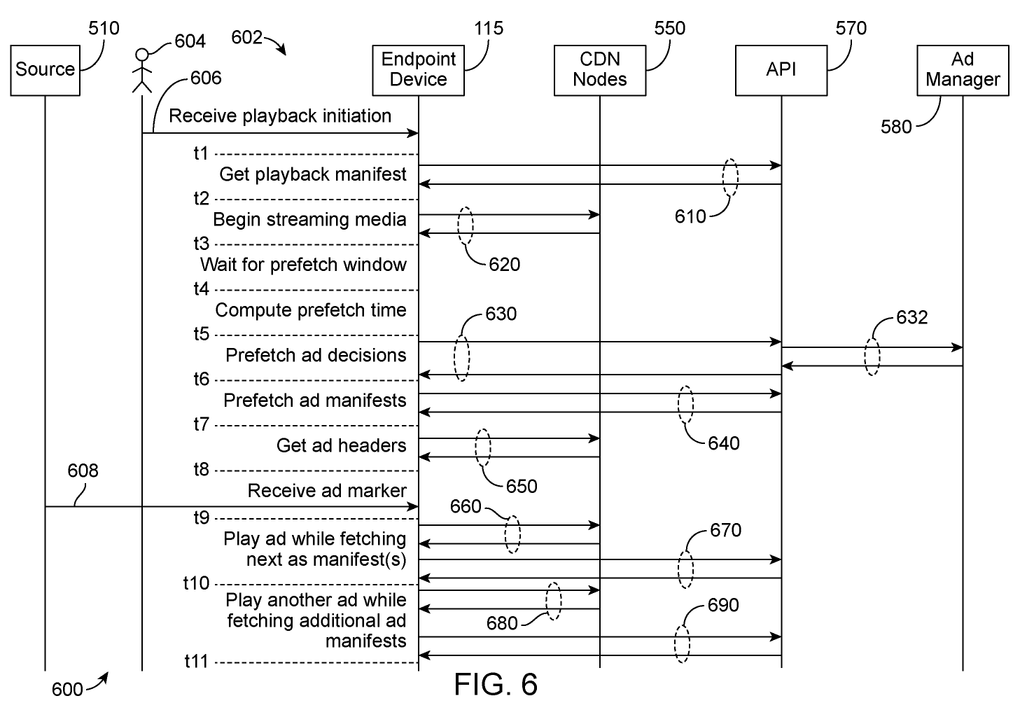

In conjunction with the operations described above, during the streaming of media titles, endpoint devices 115 can occasionally suspend streaming of primary audiovisual content associated with media titles and instead stream auxiliary media content associated with one or more advertisements (ads) during an ad break. In particular, when streaming a given media title, a given endpoint device 115 can request various types of ad information from APIs 570. In response, APIs 570 can access ad managers 580 and/or data storage 590 in order to provide the requested ad information. Based on the provided ad information, and based on ad markers received via the network infrastructure 500, endpoint device 115 can then temporarily interrupt streaming of the media title in order to stream one or more ads during an ad break. Ad information can include ad decisions 582 distributed by ad managers 580 and/or ad manifests 592 distributed by data storage 590. Ad decisions 582 indicate specific ads that should play during any given ad break. Ad manifests 592 include uniform resource locators (URLs) for audiovisual content corresponding to ads. Ads generally correspond to short media titles that are cached via CDN nodes 550 in like fashion as any of the other audiovisual content described herein. Various operations performed by endpoint devices 115 to coordinate ad playback during ad breaks are described below in conjunction with FIG. 6.

In various embodiments, multiple sources 510 are coupled to multiple downstream encoders 520, multiple encoders 520 are coupled to multiple downstream packagers 530, multiple packagers 530 are coupled to multiple downstream origins 540, multiple origins 540 are coupled to multiple downstream CDN nodes 550, multiple CDN nodes 550 are coupled to multiple downstream endpoint devices 115, multiple endpoint devices 115 are coupled to multiple downstream APIs 570, multiple APIs 570 are coupled to multiple downstream ad managers 580, and any given API 570 may be coupled to any form of data storage 590. Accordingly, the network infrastructure 500 forms a distributed content generation and distribution system. In one embodiment, the network infrastructure 500 may process segments of audiovisual content having a fixed duration, such as two seconds, for example and without limitation. In this configuration, any given segment of audiovisual content may include portions of one or more video streams and/or portions of one or more audio streams that are processed by successive components of the network infrastructure 500. In various other embodiments, segments of audiovisual content may have a variable duration that changes over the course of any given media title. In various embodiments, any given component of the network infrastructure 500 may be configured to complete all processing operations associated with any given segment of audiovisual content within a time frame that is proportional to the fixed duration of each segment, thereby supporting the ability to stream media titles associated with live events in real time and with minimal delay.

In operation, the endpoint device 115 performs a sequence 602 of operations across times t1 through t11 in order to coordinate the playback of one or more ads when streaming a media title associated with a live event occurring in real time. In addition, in various embodiments, endpoint device 115 may perform the sequence of operations 602 when streaming at a “live edge” of the media title. As referred to herein, the live edge of a given media title generally refers to a playback position in the media title corresponding to a present moment in time, and, more specifically, to a playback position in the media title corresponding to a at least one of a set of newly available segments of audiovisual content beyond which no additional segments of audiovisual content are yet available. Although the techniques described herein are generally applicable to live streaming sessions where the endpoint device streams at the live edge, persons skilled in the art will recognize that the disclosed techniques can also be applied to SVOD configurations as well as any other technically feasible variety of streaming configuration, including those where the endpoint device streams “behind” the live edge, where the playback position is several seconds or minutes away from the live edge, but the live event is still in progress.

Endpoint device 115 initiates the sequence 602 of operations in response to receiving from a user 604 a playback initiation 606 at time t1. For example, and without limitation, the user 604 could select a “play” button associated with a media title corresponding to a live event that is occurring in real time or planned to occur at an imminent future time. In response, at time t2, endpoint device 115 coordinates network interactions 610 with API 570 in order to obtain a playback manifest associated with the media title. In response, the API 570 may communicate with the ad manager 580 to determine whether the media title includes any ads and potentially determine prefetch window timing for such ads. In addition, the API 570 can further retrieve one or more sets of ad decisions and/or one or more ad manifests, potentially obviating the need for additional separate API calls for such data, although consolidating API calls in this manner can be skipped when server load is high, such as at the start of streaming. The playback manifest includes various information the endpoint device 115 needs in order to stream the media title, including a start time, a segment duration, and one or more URLs associated with audiovisual content included in the media title, among other data. In addition, the playback manifest includes configuration information related to a “prefetch interval” within which the endpoint device 115 can access ad information in advance of an upcoming ad break. In one embodiment, the endpoint device 115 may prefetch one or more ad manifests 592 at time t2 corresponding to an upcoming ad break.

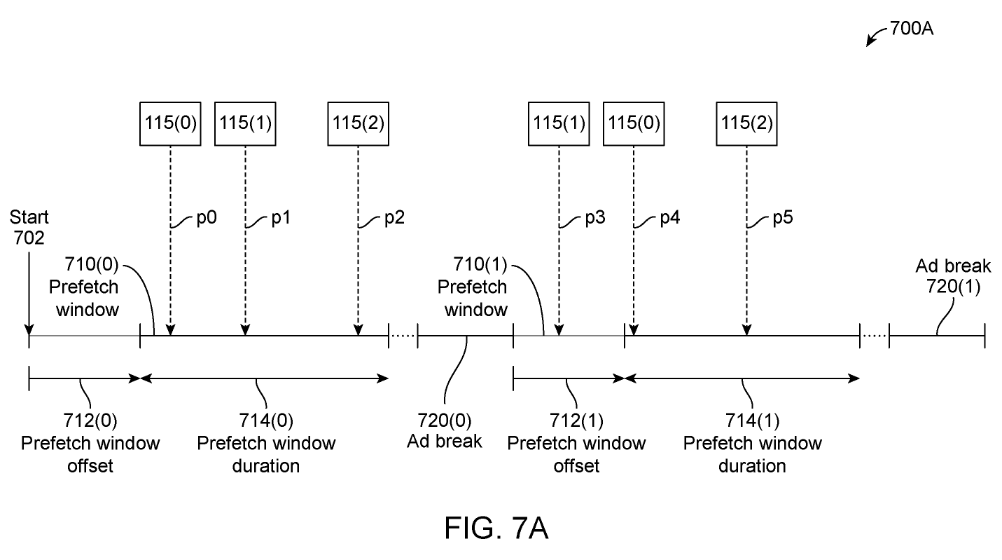

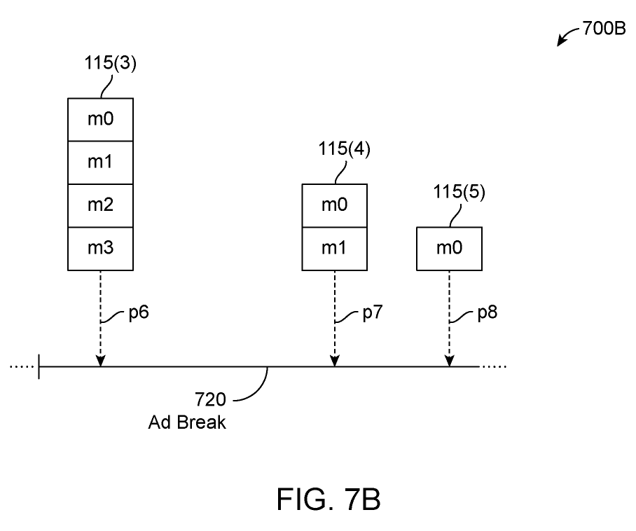

Based on the playback manifest, the endpoint device 115 begins streaming the media title at time t3 via network interactions 620 with CDN nodes 550. In some instances, streaming commences at the live edge. For example, and without limitation, the endpoint device 115 could begin streaming a media title associated with a live event that is already in progress and join at the live edge. In other instances, streaming may delay until a certain time, and then commence at the live edge. For example, and without limitation, the endpoint device 115 could wait for a live event to begin, and then only commence streaming of the media title at the live edge when the event begins. While streaming the media title, the endpoint device 115 begins waiting at time t4 for the prefetch window to arrive. As described in greater detail below in conjunction with FIG. 7A, in various embodiments, the prefetch window is defined by an offset and a duration. At time t5, the prefetch window arrives, and the endpoint device 115 computes a prefetch time within the prefetch window. In one embodiment, the endpoint device 115 computes a randomized prefetch time within the prefetch window. In another embodiment, the endpoint device 115 may compute a prefetch time based on various operational attributes of the endpoint device 115 and/or network infrastructure 500. In various embodiments, the endpoint device 115 may compute the prefetch time before the prefetch window arrives. In various other embodiments, the ad managers 580 compute prefetch times on behalf of endpoint device 115 and include those prefetch times in ad manifests distributed to the endpoint devices 115.

At time t6, corresponding to the computed prefetch time, the endpoint device 115 prefetches ad decisions 582 from the ad manager 580 for one or more upcoming ad breaks via network interactions 630 with the API 570 and network interactions 632 between the API 570 and the ad manager 580. The one or more upcoming ad breaks could represent alternative ad break options or sequential ad breaks. The ad decisions 582 indicate one or more specific types of ad break that can occur along with identifiers that indicate the particular ads that could play during any indicated ad break. In various embodiments, the ad decisions 582 may be consistent across any endpoint device 115 streaming a given live event, thereby facilitating a shared user experience where all users are presented with the same ads for a given playback position. In other embodiments, the ad decisions 582 vary between users and may be dynamically generated based on the location of the endpoint device 115, user demographics, user preferences, and other dynamic information. In some embodiments, the ad decisions 582 include information about the user experience that should be provided during the ad break. For example, and without limitation, whether player controls (e.g., seek, skip) are available and what to show on the screen to indicate that an ad break is in progress (e.g., "ads" or "back soon" or nothing). In various embodiments, the endpoint device 115 may receive one or more ad manifests 592 along with the ad decisions 582 prefetched at time t6.

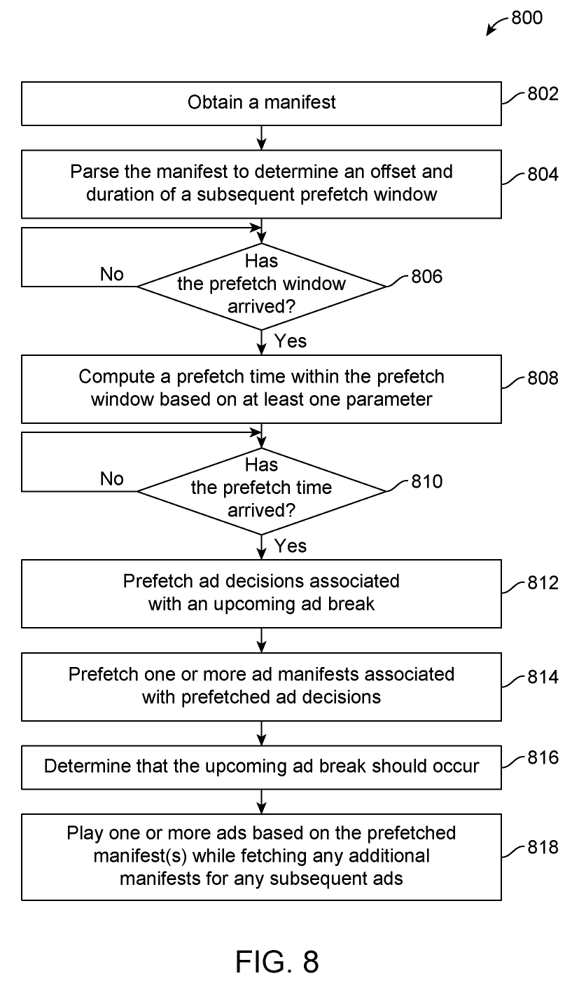

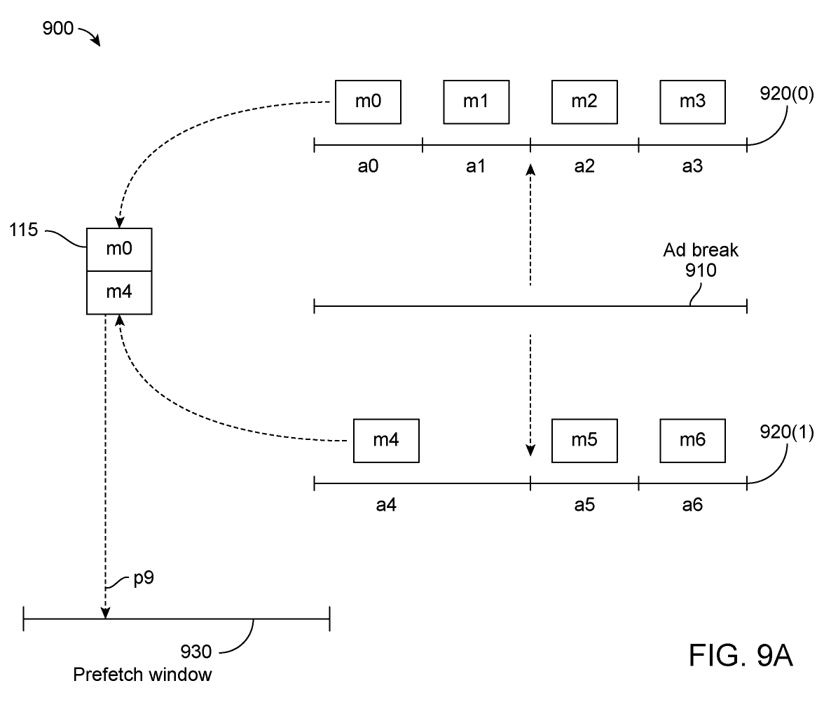

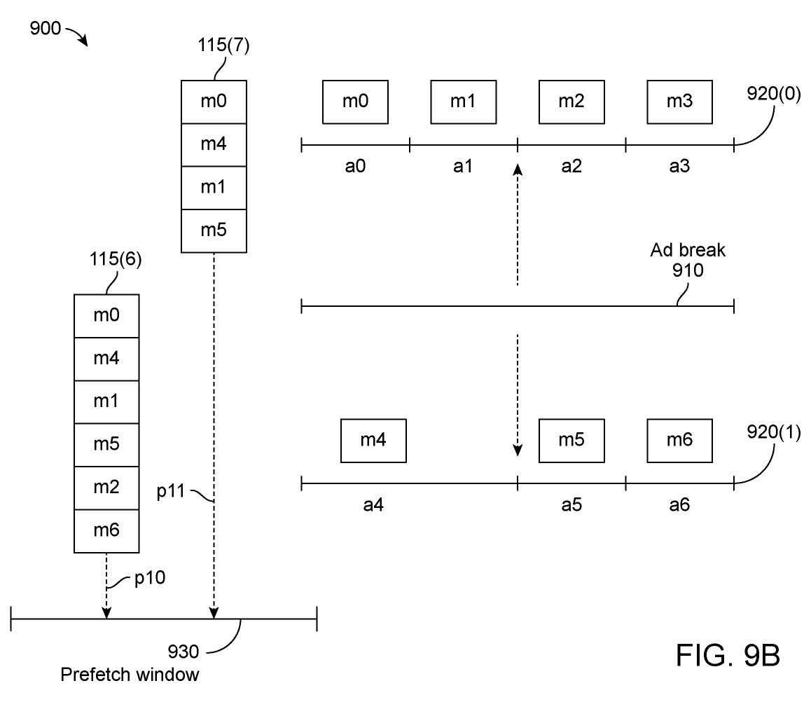

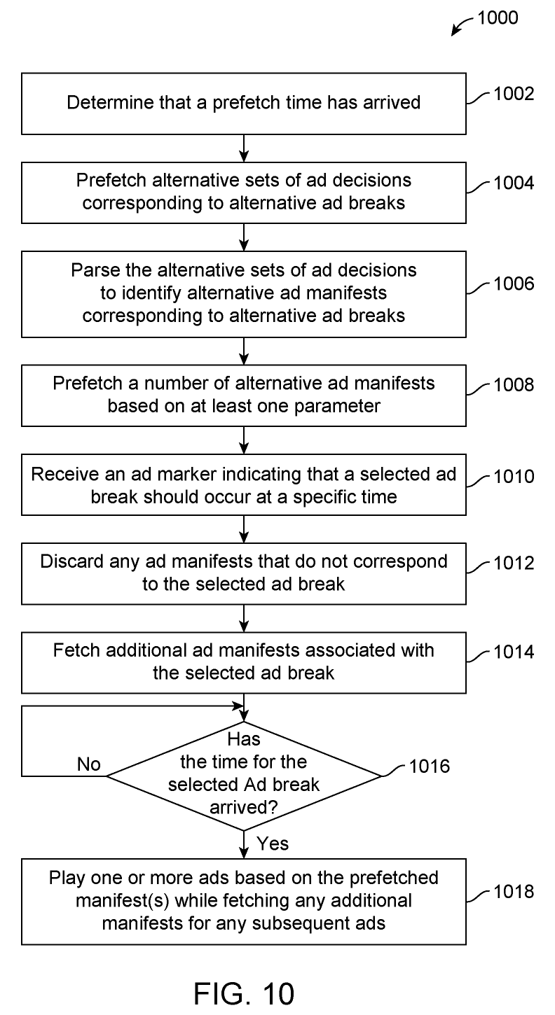

At time t7, based on the ad decisions 582, the endpoint device 115 prefetches one or more ad manifests 592 associated with the ads set forth in the ad decisions 582 via network interactions 640. An ad manifest 592 includes various information the endpoint device 115 needs in order to play a media title corresponding to the ad. In various embodiments, an ad manifest request includes information about the media format of the live event (e.g., codecs, frame rate, dynamic range) which may be used by the ad managers 580 to deliver ad content that is compatible with the live event and can be seamlessly spliced together on devices with various operational constraints, such as minimal support for codec changes, for example and without limitation. As mentioned above, ads are generally stored in the CDN nodes 550 as short media titles similar to the other media titles described herein. A given ad manifest 592 may include an ad identifier, one or more URLs associated with the media title corresponding to the ad, as well as configuration information indicating a subsequent prefetch interval within which the endpoint device 115 can access additional ad manifests 592 associated with additional ad breaks. In some embodiments, the endpoint device 115 may prefetch the ad manifest 592 for the first ad to be played during the subsequent ad break, and may also prefetch additional ad manifests 592 depending on various resource constraints, as also described below in conjunction with FIGS. 7A-8. In other embodiments, the endpoint device 115 may fetch multiple alternative ad manifests 592 associated with different alternative ad breaks that may occur, as also described below in conjunction with FIGS. 9A-10. In various embodiments, the endpoint device 115 may prefetch a number of ad manifests 592 for each possible ad break based on various resource constraints. In one embodiment, the endpoint device 115 prefetches ad decisions 582 and corresponding ad manifests 592 using the same network interaction.

At time t8, the endpoint device 115 retrieves one or more ad headers from CDN nodes 550 based on the corresponding ad manifests 592 via network interactions 650. Accessing the ad headers in this manner causes the CDN nodes 550 to pre-load any media titles associated with those ad headers, thereby pre-caching these media titles or “warming” the CDN where the CDN nodes 550 reside. At time t9, the endpoint device 115 receives an ad marker 608. The ad marker 608 includes an identifier corresponding to the upcoming ad break which, based on prefetched ad decisions, implies specific ad content. The ad marker 608 may also include a frame location in the primary audiovisual content associated with the media title where the auxiliary media content associated with the ad break should begin and splicing of the first ad should occur, as well as an ad break duration. In one embodiment, Society of Cable Telecommunications Engineers (SCTE) 35 markers may be used to implement ad markers. In various embodiments, ad signaling may be provided during a pre-roll period that occurs in advance of a particular reference frame where ad insertion is scheduled to occur and may continue for the duration of the auxiliary media content associated with the ad(s). Upon receiving the ad marker 608 from the source 510, the endpoint device 115 may continue to output primary audiovisual content associated with buffered segments of the media title for a period of time before switching to auxiliary media content associated with an ad break. During that time, the endpoint device 115 can begin streaming the auxiliary media content associated with one or more ads, as described below.

At time t10, based on the prefetched ad manifest(s) 592, the endpoint device 115 determines that the first ad included in the ad break should be streamed for subsequent playback. In practice, the endpoint device 115 may begin downloading auxiliary media content associated with one or more ads at time t10 while playing buffered primary audiovisual content associated with the media title, and then switch to outputting the auxiliary media content. When such buffered primary audiovisual content is depleted, the endpoint device 115 then begins streaming auxiliary media content corresponding to the first ad via network interactions 660 with the CDN nodes 550. In so doing, the endpoint device 115 uses the URLs included in a first ad manifest associated with the first ad to request and then subsequently display segments of audiovisual content associated with the first ad. In conjunction with these operations, the endpoint device 115 also fetches one or more additional ad manifests via network interactions 670 with the API 570. By fetching additional ad manifests while playing a given ad, the endpoint device 115 can prepare for playing subsequent ads. When the first ad manifest is no longer needed, the endpoint device 115 can discard the first ad manifest, thereby freeing memory resources for subsequent ad manifests.

At time t11, the first ad has finished playing, and the endpoint device 115 has already stored a second ad manifest for the second ad via the operations described above. In some situations, the endpoint device 115 may have prefetched the second ad manifest well in advance, at time t7. In other embodiments, the endpoint device 115 may have fetched the second ad manifest after time t10, at a randomly selected time during playback of the first ad. The endpoint device 115 can then begin streaming auxiliary media content corresponding to the second ad via network interactions 680 with the CDN nodes 550. In particular, the endpoint device 115 uses the URLs included in the second ad manifest to request and then subsequently display segments of audiovisual content associated with the second ad. When the second ad manifest is no longer needed, the endpoint device 115 can discard the second ad manifest, thereby freeing memory resources for subsequent ad manifests. In conjunction with these operations, the endpoint device 115 may also fetch additional ad manifests in order to prepare for the playback of subsequent ads. In various embodiments, if there are n ads in an ad break and the endpoint device 115 prefetched m < n manifests during the prefetch window (at t7), then the requests for the remaining (n-m) manifests can be spread randomly and in order over the time between the beginning of the ad break and the beginning of the last ad, subject to the constraint that each manifest must be requested before the corresponding ad.

When playback of the second ad completes, the endpoint device 115 can then play additional ads based on any additional ad manifests or, alternatively, if the ad break is complete, return to streaming the media title corresponding to the live event in like fashion as described above relative to time t3. While streaming the media title, the endpoint device 115 waits for a subsequent prefetch window corresponding to any given known or unknown subsequent ad break. As mentioned above, previously fetched ad information can specify future prefetch windows, where those prefetch windows can be defined by an offset and a duration.

Via the sequence of operations 602 described above, the endpoint device 115 can stream a media title corresponding to a live event and then temporarily stop or divert playback of that media title during an ad break in order to stream one or more media titles corresponding to one or more ads. Furthermore, the sequence of operations 602 addresses two key technical issues that can arise in conventional streaming platforms when vast numbers of clients simultaneously stream a given media title at the live edge. In particular, when an ad break occurs during a live event, a large multitude of clients typically attempt to access the same ad information from an ad server at the same time. In conventional streaming platforms, under these conditions, the ad server can easily become overwhelmed with requests. To address this particular technical issue, endpoint devices 115 are configured to distribute requests for ad information across the prefetch window in the manner described above, helping to prevent the ad manager 580 from being overwhelmed by an excessive number of simultaneous requests. This functionality is described in greater detail below in conjunction with FIGS. 7A-8. In addition, during many types of live events, the timing of ad breaks and the specific types of ads that will play during any given ad break can be unknown. In conventional streaming platforms, under these conditions, clients sometimes have very little time to fetch ad information from the ad server and therefore must do so within a short timeframe, potentially causing the ad server to become overwhelmed with requests. To address this particular technical issue, endpoint devices 115 are configured to prefetch multiple alternative ad breaks and/or ad manifests during the prefetch window in the manner described above, helping to prevent the ad manager 580 from being overwhelmed by an excessive number of simultaneous requests. This functionality is described in greater detail below in conjunction with FIGS. 9A-10.

### Distributing Prefetch Requests Across a Prefetch Window

FIGS. 7A-7B illustrate how endpoint devices distribute requests for ad information across a prefetch window during live streaming, according to various embodiments. As shown in FIG. 7A, a timeline 700A includes various intervals that occur during playback of a media title corresponding to a live event, including prefetch windows 710 and ad breaks 720. A given prefetch window 710 is defined by a prefetch window offset 712 and a prefetch window duration 714. During any given prefetch window 710, multiple endpoint devices 115 can issue prefetch requests for ad information, including ad decisions 582 and/or ad manifests 592, in preparation for an upcoming ad break 720.

A given endpoint device 115 can stream the media title at the live edge of the live event after the start 702 of the live event. In so doing, the endpoint device 115 fetches a playback manifest associated with the media title, as mentioned above in conjunction with FIG. 6, and then uses the playback manifest to begin streaming audiovisual content. As also mentioned, the playback manifest includes information describing a prefetch window within which endpoint devices 115 can prefetch ad information associated with an upcoming ad break.

As is shown, an initial prefetch window 710(0) is defined by an initial prefetch window offset 712(0) defined relative to the start 702 of the media title as well as an initial prefetch window duration 714(0). The prefetch window offset 712(0) and prefetch window duration 714(0) are included in the playback manifest. The prefetch window offset 712(0) is a span of time between the start 702 of the media title and the start of the prefetch window 710(0). The prefetch window duration 714(0) defines a duration of time, after the prefetch window offset 712(0), when the prefetch window 710(0) occurs. When the prefetch window 714(0) arrives, or beforehand, each endpoint device 115 streaming the media title selects a prefetch time between the start and end of the prefetch window 714(0), and prefetches ad information, including ad decisions 582 and/or ad manifests 592, at the selected time. In the example described herein, during prefetch window 710(0), endpoint devices 115(0), 115(1), and 115(2) prefetch ad information at prefetch times p0, p1, and p2, respectively. The prefetched ad information allows the endpoint devices 115 to prepare for the upcoming ad break 720(0). In addition, one or more ad manifests 592 prefetched during the prefetch window 710(0) include information specifying a prefetch window offset 712(1) defined relative to the ad break 720(0) and a prefetch window duration 714(1) associated with a subsequent ad break 720(1). Accordingly, when the prefetch window 710(1) arrives subsequent to the start 702 of the media title by an amount of time given by the prefetch window offset 712(0), the endpoint devices 115 select a prefetch time during the prefetch window 710(1) at which to prefetch ad information related to another ad break 720(1), including additional ad decisions 582 and/or ad manifests 592. In the example shown, endpoint devices 115(0), 115(1), and 115(2) prefetch ad information at prefetch times p4, p3, and p5, respectively. As a general matter, any given set of ad information and/or manifest can include information describing a prefetch window within which ad information should be prefetched to prepare for a subsequent ad break.

In one embodiment, the endpoint devices 115 randomly select a prefetch time during any given prefetch window 710 to fetch ad information based on a randomized parameter value. Randomly selecting prefetch times distributes prefetch requests across the prefetch window 710, which reduces instantaneous load on the ad manager 582 and lowers the likelihood that the ad manager 582 becomes overwhelmed when servicing requests. In various embodiments, the endpoint devices 115 may then prioritize times to request additional ad information based on resource constraints, including memory limitations, as described in greater detail below in conjunction with FIG. 7B.

As shown in FIG. 7B, a timeline 700B includes an ad break 720. During the ad break 720, in various embodiments, endpoint devices 115 can select times to fetch additional ad manifests corresponding to other ads to be played during the ad break 720 based on an amount of memory that is available for storing manifests. Some endpoint devices 115 may have sufficient memory resources to store numerous manifests, while other endpoint devices 115 may have more limited memory resources. In order to accommodate such differences, endpoint devices 115 with a greater amount of available memory can be configured to prioritize fetching ad manifests earlier during the ad break 720 compared to endpoint devices 115 with a lower amount of available memory.

For example, and without limitation, endpoint device 115(3) includes memory resources that are sufficient to store ad manifests m0, m1, m2, and m3 and therefore selects a time p6 that is relatively early during the ad break 720. The endpoint device 115(3) can, in this manner, potentially retrieve all ad manifests needed for the ad break 720 during playback of the first ad. Endpoint device 115(4) includes memory resources that are sufficient to store ad manifests m0 and m1 and therefore selects a time p7 that is midway through the ad break 720. Endpoint device 115(5) only includes sufficient memory resources to store ad manifest m0 and therefore selects a time p8 that is later in the ad break 720. In this example, the endpoint device 115(5) may only have sufficient memory capacity to store the ad manifest for the very next ad in the ad break 720, and therefore can only retrieve a given ad manifest just before that manifest is needed. Endpoint devices 115 are configured to prioritize times for retrieving manifests in the manner described in order to saturate as many endpoint devices 115 with ad manifests as possible. Among other things, retrieving ad manifests incurs latency, and, thus, endpoint devices 115 with greater memory capacity for storing ad manifests need more time to fully populate those memory resources with ad manifests.

Referring generally to FIGS. 7A-7B, the disclosed techniques can be implemented by endpoint devices 115 in order to distribute requests for ad information across time and therefore reduce instantaneous load on the ad server 580. Although the techniques described above are specifically applicable to live streaming configurations, persons skilled in the art will understand that the disclosed techniques can be implemented in the SVOD configurations, as well.

FIG. 8 is a flow diagram of method steps for prefetching ad information during live streaming, according to various embodiments. Although the method steps are described in conjunction with the systems of FIGS. 1-8, persons skilled in the art will understand that any system configured to perform the method steps, in any order, is within the scope of the present invention.

As shown, a method 800 begins at step 802, where an endpoint device 115 obtains a manifest. The manifest can be a playback manifest that the endpoint device 115 receives when playback is initiated, or an ad manifest that is obtained subsequently during playback. In the former case, at step 802 the endpoint device 115 may commence streaming audiovisual content associated with a corresponding media title. In either case, the manifest includes information describing a subsequent prefetch window associated with an upcoming ad break.

At step 804, the endpoint device 115 parses the manifest to determine an offset and a duration of the subsequent prefetch window. If the manifest is a playback manifest, then the offset may indicate a time delay after the start of the media title at which the prefetch window begins. If the manifest is an ad manifest, then the offset may indicate a time delay after the end of a previous ad break at which the prefetch window begins. In either case, the duration indicates how long the subsequent prefetch window should occur. Persons skilled in the art will understand that prefetch windows can be defined using any technically feasible form of data other than offsets and durations.

At step 806, the endpoint device 115 determines whether the prefetch window has arrived. During this time, the endpoint device 115 continues to stream audiovisual content associated with the media title. If the prefetch window has not arrived, the endpoint device 115 waits and periodically repeats step 806. Otherwise, the endpoint device 115 proceeds to step 808.

At step 808, when the prefetch window arrives, the endpoint device 115 computes a prefetch time within the prefetch window based on at least one parameter. In one embodiment, the at least one parameter is a randomized value based on which the endpoint device randomly selects the prefetch time. Randomly selecting prefetch times distributes prefetch requests across the prefetch window, which reduces the instantaneous load on the ad manager 582 and reduces the likelihood that the ad manager 582 becomes overwhelmed servicing requests. In another embodiment, the endpoint device 115 may select a prefetch time within the prefetch window based on resource constraints, including memory limitations, and/or network bandwidth, among other possible constraints.

At step 810, the endpoint device 115 determines whether the prefetch time has arrived. The endpoint device 115 continues to stream audiovisual content associated with the media title while periodically checking whether the prefetch time has arrived. If the prefetch time has not arrived, the endpoint device 115 waits and periodically repeats step 810. Otherwise, the endpoint device 115 proceeds to step 812.

At step 812, the endpoint device 115 prefetches ad decisions associated with an upcoming ad break. The ad decisions for a given ad break indicate the specific ads that should play during the ad break. In one embodiment, the ad decisions include an identifier corresponding to a specific type of ad break as well as one or more identifiers corresponding to the one or more ads to be included in the ad break. In various embodiments, the endpoint device 115 fetches multiple ad decisions corresponding to multiple alternative ad breaks, as described in greater detail below in conjunction with FIGS. 9A-10.

At step 814, the endpoint device 114 prefetches one or more ad manifests associated with the ad decisions prefetched at step 812. A given ad manifest includes various information the endpoint device 115 needs in order to play a media title corresponding to the ad. As mentioned above, ads are generally stored in the CDN nodes 550 as short media titles similar to the other media titles described herein. A given ad manifest may include an ad identifier, one or more URLs associated with the media title corresponding to the ad, and configuration information indicating a subsequent prefetch interval within which the endpoint device 115 can access additional ad manifests 582 associated with additional ad breaks. In some embodiments, the endpoint device 115 may prefetch the ad manifest for the first ad to be played during the subsequent ad break, and may also fetch additional ad manifests depending on various resource constraints, as described above in conjunction with FIG. 7B.

At step 816, the endpoint device 115 determines that the upcoming ad break should occur. In one embodiment, the endpoint device 115 receives an ad marker at step 816. The ad marker includes an identifier corresponding to the ad break and/or the first ad that should be played during the ad break. The ad marker 608 may also include a frame location in the primary media title where the ad break should begin and where splicing of the first ad should occur. In one embodiment, SCTE 35 markers may be used to implement ad markers.

At step 818, the endpoint device 115 plays one or more ads based on the prefetched manifest(s) while fetching any additional manifests for any subsequent ads. When playing a given ad, the endpoint device 115 uses the corresponding ad manifest to stream audiovisual content associated with the ad from CDN nodes 550. While streaming the audiovisual content, the endpoint device 115 can opportunistically fetch additional ad manifests to prepare for the seamless playback of additional ads. During streaming of a given ad, when the corresponding ad manifest is no longer needed, the endpoint device 115 can discard that ad manifest, thereby freeing storage resources for additional ad manifests.

The techniques described above in conjunction with FIGS. 6-7B generally address problems that can arise when a large multitude of clients attempt to access ad information from an ad server during live streaming. In particular, by scheduling endpoint devices to prefetch ad information in advance of ad breaks, and distributing the associated prefetch requests across a prefetch window, large spikes in traffic can be avoided, potentially preventing the ad manager from becoming overwhelmed with traffic and unable to service requests.

### Prefetching Ad Information for Multiple Alternative Ad Breaks

As mentioned above in conjunction with FIG. 5, in a live streaming configuration, a control center located at a broadcast location where a live event is occurring coordinates the production of audiovisual content associated with the live event. The control center typically includes a team of human operators who monitor both the production of the audiovisual content and the progress of the live event. In response to specific, unpredictable occurrences, the human operators sometimes manually intervene in the production of the audiovisual content in order to perform various adjustments.

For example, and without limitation, in sporting events, timeouts are generally unpredictable, and when a timeout is called, human operators in the control center may decide to temporarily suspend streaming of the live event and transition into an ad break. Live events can present many different types of unpredictable occurrences that interrupt the general flow of the live event. Such occurrences may include technical difficulties, inclement weather, unforeseen injuries, disputes among participants, and spectator-induced distractions. The human operators may decide to transition to a specific type of ad break depending on the particular type of unpredictable occurrence involved. In some instances, ad break unpredictability occurs due to ad sales models in which advertisers can purchase spots that are guaranteed to occur at certain times within the event, such as in National Football League (NFL) near the end of a specific quarter or during a time out vs within the half-time segment. Because the duration of the quarter and the number of time-outs are unknown there is uncertainty about which break is next, for example between a regular time-out break and the end-of-quarter break, without limitation.

Accordingly, as a general matter, during streaming of live events, the timing of ad breaks and the specific types of ads that should play during any given ad break can remain unknown until shortly before the ad break should occur. In this situation, a large multitude of clients may attempt to access an ad server within a brief timeframe, potentially causing the ad server to become overwhelmed. The techniques described below in conjunction with FIGS. 9A-10 address these technical issues.

FIGS. 9A-9B illustrate how endpoint devices prefetch ad information associated with alternative possible ad breaks during live streaming, according to various embodiments. As shown in FIG. 9A, a generic ad break 910 corresponds to alternative ad breaks 920(0) and 920(1). Alternative ad breaks 920 represent at least two possible types of ad breaks that can occur at any given time. In one embodiment, the set of possible alternative ad breaks 920 that can occur for any given generic ad break 910 can be derived from a history of ad breaks that have already occurred. In other embodiments, the set of possible alternative ad breaks 920 can depend on conditions associated with the live event. Alternative ad breaks 920 correspond to different ad decisions and therefore include different sets of ads.

As is shown, the alternative ad break 920(0) includes ads a0, a1, a2, and a3, while the alternative ad break 920(1) includes ads a4, a5, and a6. Each ad can be played by a given endpoint device 115 based on a corresponding ad manifest. In particular, ads a0, a1, a2, and a3 can be played by the endpoint device 115 using manifests m0, m1, m2, and m3, respectively, while ads a4, a5, and a6 can be played by the endpoint device 115 using manifests m4, m5, and m6, respectively. The ad decisions associated with any given alternative ad break 920 generally indicate in some fashion the specific ad manifests needed to play the corresponding ads.

In order to prepare for either of the alternative ad breaks 920, the endpoint device 115 is configured to prefetch alternative sets of ad decisions associated with each alternative ad break 920 and then prefetch one or more ad manifests specified in each set of ad decisions. In the example shown, the endpoint device 115 is configured to prefetch ad manifest m0 and ad manifest m4 at prefetch time p9 within the prefetch window 930. Prefetching alternative ad decisions and one or more ad manifests associated with those alternative ad decisions allows the endpoint device 115 to prepare in advance for multiple possible ad breaks, thereby reducing load on the ad manager 580. In various embodiments, the endpoint device 115 can also fetch multiple optional ad decisions for any given ad break, thereby allowing a given ad break to be extended on an as-needed basis. For example, in sporting events, injury breaks sometimes need to be extended via additional injury breaks until gameplay can resume. Accordingly, a given alternative ad break may include multiple sets of ad decisions that describe an initial sequence of ads as well as an optional additional sequence of ads.

Subsequently, the endpoint device 115 receives an ad marker indicating that a specific ad break should commence. In response to the ad marker, the endpoint device 115 uses any prefetched ad manifests associated with the specified ad break to begin streaming audiovisual content associated with the relevant ads. In addition, the endpoint device 115 can discard any unneeded ad manifests associated with any alternative ad breaks that are not planned to occur, and begin fetching additional ad manifests for the ad break that is in progress. In the example shown, if the endpoint device 115 receives an ad marker indicating that the alternative ad break 920(0) should commence, then the endpoint device can use manifest m0 to begin playing ad a0 with minimal delay. The endpoint device 115 can also discard manifest m4 and then fetch manifest m1 in preparation for playing ad a1. Prefetching alternative ad decisions and ad manifests in the manner described helps to address situations where both the timing and type of upcoming ad breaks are unknown and/or unpredictable. Further, when prefetching occurs during the prefetch window 930, using the techniques described above in conjunction with FIGS. 6-8, spikes in request volume to the API 570 and the ad manager 580 can be minimized. In various embodiments, prefetching of alternative ad manifests can also occur during the prefetch window in a prioritized manner based on various device and/or network constraints, as described below in conjunction with FIG. 9B.

As shown in FIG. 9B, the endpoint devices 115(6) and 115(7) have different memory capacities and are therefore configured to prefetch ad manifests associated with the alternative ad breaks 920 at different times during the prefetch window 930. In particular, the endpoint device 115(6) can store up to six ad manifests and is therefore prioritized to prefetch ad manifests earlier in the prefetch window 930 compared to the endpoint device 115(7), which can only store four ad manifests. In various embodiments, the endpoint devices 115 are configured to select a prefetch time based, at least in part, on an amount of memory that is available to store ad manifests. In the example described herein, the endpoint devices 115(6) and 115(7) prefetch the first ad manifest associated with each of the alternative ad breaks 920(0) and 920(1), then prefetch the second ad manifest associated with each of the alternative ad breaks 920(0) and 920(1), and so forth until no additional memory capacity remains. In various other embodiments, a given endpoint device 115 computes a number of ad manifests that can be prefetched for any given alternative ad break 920, and then prefetches that number of ad manifests. Although the techniques described above refer to just two possible alternative ad breaks 920, the disclosed techniques are equally applicable to any number of alternative ad breaks.

Referring generally to FIGS. 7A-7B and 9A-9B, persons skilled in the art will understand how the different techniques disclosed in conjunction with these figures can be combined in order to optimize the dynamic insertion of ads during live streaming. Further, persons skilled in the art will recognize that the exemplary configurations described in conjunction with these figures are provided for illustrative purposes and not meant to be limiting.

FIG. 10 is a flow diagram of method steps for prefetching alternative ad information during live streaming, according to various embodiments. Although the method steps are described in conjunction with the systems of FIGS. 1-9A, persons skilled in the art will understand that any system configured to perform the method steps, in any order, is within the scope of the present invention.

As shown, a method 1000 begins at step 1002, where an endpoint device 115 determines that a prefetch time has arrived. The endpoint device 115 is configured to first determine a prefetch window based on a playback manifest or an ad manifest in the manner described above in conjunction with FIGS. 6-8. Then, the endpoint device determines the prefetch time using any of the techniques described thus far, which include randomly selecting a prefetch time within the prefetch window or determining a prefetch time based on an amount of available memory resources.

At step 1004, the endpoint device 115 prefetches alternative sets of ad decisions corresponding to alternative ad breaks. During a live event, the timing of ad breaks and the type of ads that play during any given ad break can be unpredictable. However, based on a history of ad breaks that have already occurred, the ad manager 582 can typically narrow down the set of all possible ad breaks to a smaller subset of alternative ad breaks. When the endpoint device 115 prefetches ad decisions at step 1004, the ad manager 580 provides only the ad decisions corresponding to that subset of alternative ad breaks.

At step 1006, the endpoint device 115 parses the alternative sets of ad decisions to identify alternative ad manifests corresponding to alternative ad breaks. A given set of ad decisions includes ad identifiers for the ads associated with the corresponding alternative ad break. The endpoint device 115 can use the ad identifiers in order to prefetch some or all ad manifests for the various alternative ad breaks.

At step 1008, the endpoint device 115 prefetches a number of alternative ad manifests based on at least one parameter. As described above in conjunction with FIGS. 9A-9B, the number of ad manifests a given endpoint device 115 can typically prefetch depends on an amount of available memory resources the endpoint device 115 has allocated for storing ad manifests. Accordingly, the number of alternative ad manifests the endpoint device 115 prefetches, and the time at which the associated prefetch requests are made, may both depend on the memory capacity of the endpoint device 115, in various embodiments.

At step 1010, the endpoint device 115 receives an ad marker indicating that a specifically selected ad break should occur at a specific time. In one embodiment, the ad marker may be a SCTE 35 marker embedded in a timed metadata track or event track. The ad marker includes one or more identifiers corresponding to one of the alternative ad breaks and/or one or more of the ads included in a given alternative ad break. Based on the ad marker, the endpoint device 115 can determine which alternative ad break should commence.

At step 1012, the endpoint device 115 discards any ad manifests that do not correspond to the selected ad break. The discarded ad manifests generally correspond to alternative ad breaks that were not selected to occur. The endpoint device 115 discards these ad manifests in order to free memory capacity for the storage of additional ad manifests associated with the selected ad break. In one embodiment, the endpoint device 115 may retain one or more ad manifests that do not correspond to the selected ad break in order to prepare for a subsequent ad break that may occur.

At step 1014, the endpoint device 115 fetches additional ad manifests associated with the selected ad break. Once the endpoint device 115 frees memory capacity by discarding unneeded ad manifests, the endpoint device 115 begins prefetching additional ad manifests in the order specified by the corresponding set of ad decisions. For example, and without limitation, in the example shown in FIG. 9A, upon discarding ad manifest m4, the endpoint device 115 would prefetch ad manifest m1. Then, once playback of ad a0 is complete, the endpoint device 115 would discard ad manifest m0 and fetch ad manifest m2.

At step 1016, the endpoint device 115 determines whether the time for the ad break has arrived. In various embodiments, the ad marker received at step 1010 indicates a specific reference frame included in the primary audiovisual content associated with the live event where auxiliary media content associated with ads can be seamlessly spliced during playback. If the time for the selected ad break has not yet arrived, then the endpoint device 115 repeats step 1016 periodically. Otherwise, the method 1000 proceeds to step 1018.

At step 1018, the endpoint device 115 plays one or more ads based on the prefetched manifest(s) while fetching any additional manifests for any subsequent ads. When the ad break commences, the endpoint device 115 suspends playback of the primary audiovisual content associated with the live event and begins streaming auxiliary media content associated with the first ad included in the selected ad break using the corresponding prefetched ad manifest. Once the prefetched ad manifest associated with the first ad is no longer needed, the endpoint device 115 discards that manifest and then begins prefetching additional ad manifests, as needed, to prepare for the playback of subsequent ads.

Although the disclosed techniques are described relative to live streaming of live events at the live edge of a corresponding media title, persons skilled in the art will understand that any of the disclosed techniques can also be applied to other streaming configurations, including live streaming behind the live edge as well as SVOD of pre-recorded media titles.

### Early Return from an Ad Break

As noted above, in a live streaming scenario, a control center located at a broadcast location where a live event occurs can be used to coordinate the production and broadcast of the event. Human operators in the control center or in communication with the control center coordinate production of the live event. Such coordination includes decisions regarding when ad breaks begin and end. In the case of a live sporting event such as an American football game, ad breaks are relatively predictable. However, the exact timing of when ad breaks occur remains unpredictable due to the ebb and flow of a particular game.

Additionally, a live sporting event can include various unpredictable occurrences at which ad breaks occur. For example, broadcast technical difficulties, weather delays, player injuries, disputes among participants, and spectator-induced distractions might take place. Human operators may decide to transition to a specific type of ad break depending on the particular type of unpredictable occurrence involved. Similarly, an ad can also end prematurely or unpredictably. For example, if an ad break is commenced due to a human operator mistakenly believing that a player on the field of the sporting event is injured, then the ad break might be cancelled shortly after commencement and before all prefetched ad decisions are played back by an endpoint device 115. As another example, an ad break might prematurely end if the event being broadcast returns to action or performance earlier than planned for by human operators coordinating the broadcast.

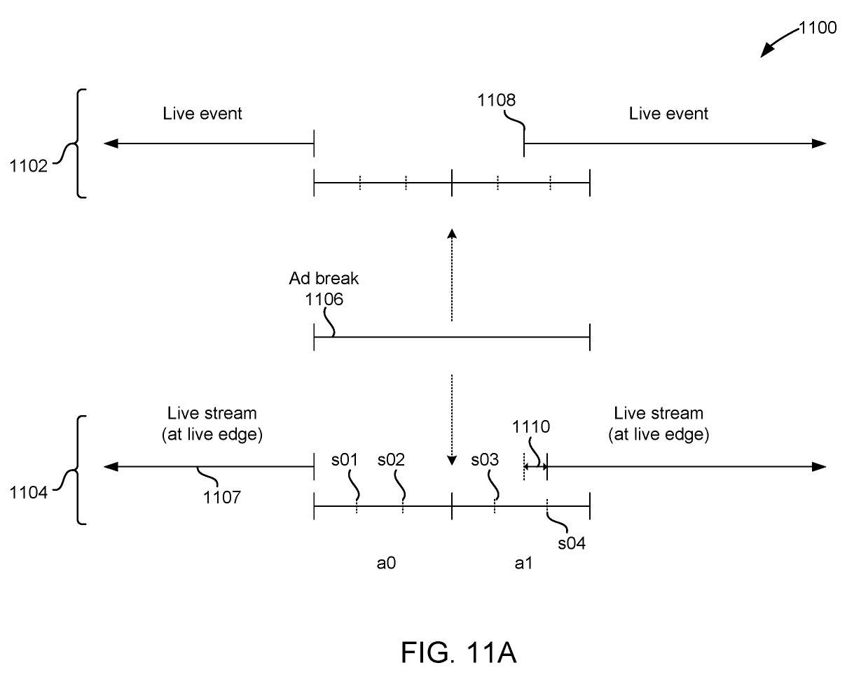

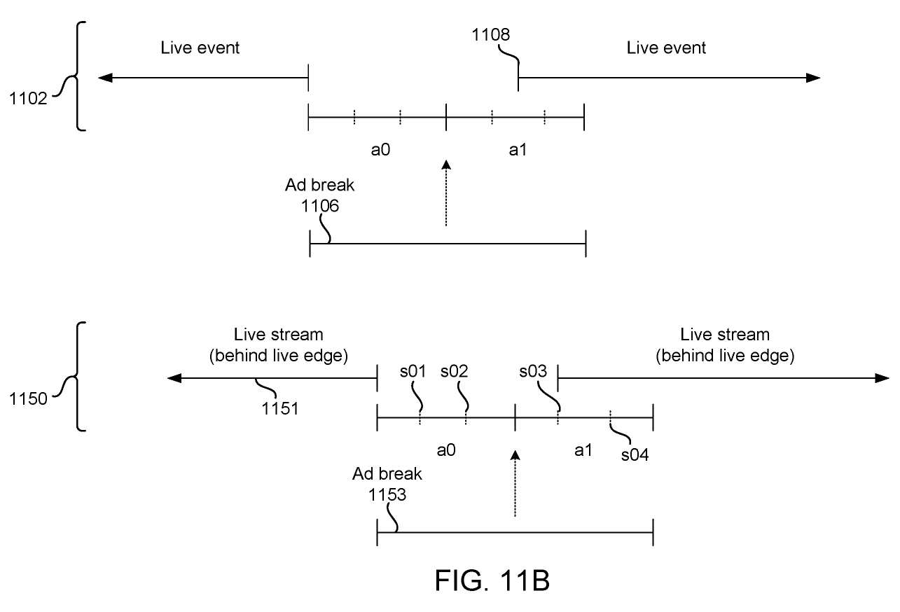

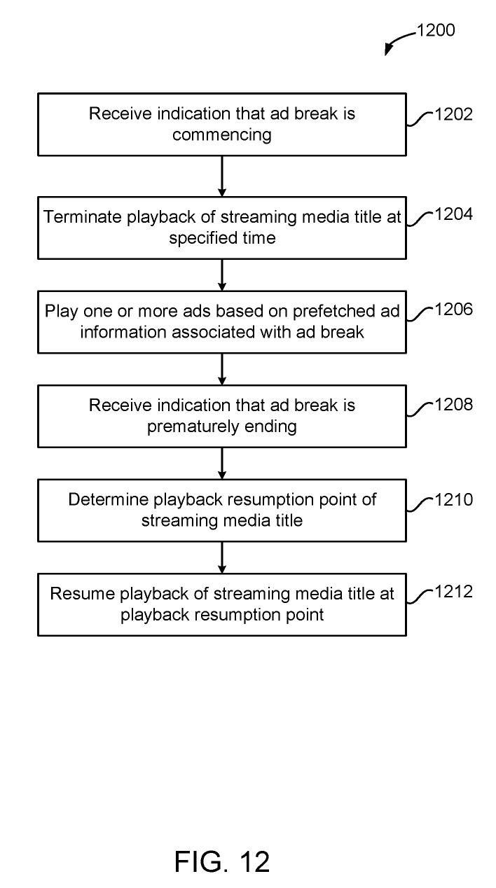

Accordingly, as a general matter, during the streaming of live events, ad breaks can end unpredictably or prematurely after commencement. In such situations, clients that are streaming the event at the live edge or behind the live edge can utilize various techniques for resuming playback of the event. The techniques described below in conjunction with FIGS. 11A-12 address these technical issues.

FIGS. 11A-11B illustrate how endpoint devices handle a scenario in which an ad break ends prematurely or unexpectedly and returns to the streaming media title. Such a scenario is also referred to herein as an early return from an ad break. As shown in FIG. 11A, timeline 1102 and timeline 1104 are shown. Timeline 1102 corresponds to the actual live event, and timeline 1104 corresponds to an endpoint device 115 that is streaming the live event at the live edge. It should be appreciated that in some cases, an endpoint device 115 streaming the live event at the live edge might be on a slight delay for censorship delays, streaming latency, or other latency or delay reasons that are not contemplated in the depicted timelines.

As shown in timeline 1102, the live event commences ad break 1106. The ad break 1106 is commenced by a human operator or an automated process causing a SCTE-35 marker to be distributed to downstream systems receiving a broadcast or streaming media title corresponding to the live event. The SCTE-35 marker is a digital message or indication informing downstream systems that the ad break 1106 is commencing. In some embodiments, the SCTE-35 marker identifying the ad break can also specify an intended duration of the ad break. As described above, endpoint device 115 prefetches ad information for ad breaks so that the manifests for the ads for playback during the ad break 1106 are already accessible to endpoint device 115. Therefore, upon receiving the indication that the ad break 1106 is commencing, an endpoint device 115 streaming the live event initiates playback of the ads based on the prefetched ad information.

As shown in FIG. 11A, timeline 1104 corresponds to playback of the live event by an endpoint device 115. Endpoint device 115 streams a first portion 1107 of a streaming media title corresponding to the live event until receiving the indication that the ad break is commencing. Upon receiving the indication, endpoint device 115 commences ad break 1106. In the example of FIG. 11A, the prefetched ad information identifies ads a0 and a1. Additionally, ad a0 includes splice points s01 and s02. Ad a1 includes splice points s03 and s04. The splice points represent points within a streaming video file corresponding to the respective ads where video corresponding to the ad can be spliced, such as at a frame boundary or another point at which the video can be spliced without dropped or missing frames. For example, a splice point represents a fragment boundary corresponding to the end of a chunk of video corresponding to the ad. In one example, the video corresponding to an ad can be broken up into discrete fragments or chunks that represent portions of an encoded media stream representing the ad. Accordingly, when streaming content, endpoint device 115 processes and plays back these fragments corresponding to the encoded media stream. As a general matter, the size of a fragment represents the seek granularity of a video stream being played back by an endpoint device 115.

Accordingly, again, upon receiving the indication that the ad break 1106 has commenced, endpoint device 115 begins playback of ads a0 and a1. As shown in FIG. 11A, the ad break 1106 terminates early at timestamp 1108. At timestamp 1108, endpoint device 115 receives an indication that the ad break 1106 is cancelled or is ending prematurely. The indication can be represented by a SCTE-35 marker or message that includes the indication that the ad break 1106 is ending prematurely.

Upon receiving such an indication, endpoint device 115 determines a playback resumption point. The playback resumption point represents a point in the ad break 1106 at which playback of ads is terminated and playback of the streaming media title resumes. In other words, in the context of a live event, the playback resumption point indicates a point in the ad break 1106 where endpoint device 115 ends the ad break 1106 and resumes playback of the live event. In the scenario depicted in FIG. 11A, endpoint device 115 selects the playback resumption point by identifying a nearest splice point s04. By selecting splice point s04, endpoint device 115 buffers playback of the live event by a buffer amount 1110 before terminating playback of the ad a1 and resuming playback of the streaming media content corresponding to the live event. Therefore, rather than immediately terminating playback of the ad a1 in the middle of a fragment or frame, endpoint device 115 waits until a fragment boundary, represented by splice point s04 in the depicted example. In some cases, a client might be constrained to splicing an ad at a splice point or fragment boundary and might be unable to splice the ad outside of a fragment boundary for video encoding purposes.

By buffering playback of the live event by buffer amount 1110, endpoint device 115 that was streaming the live event at the live edge is now behind the live edge by the buffer amount 1110. Accordingly, in one embodiment, endpoint device 115 can simply remain behind the live edge by the buffer amount 1110. Endpoint device 115 can also utilize various techniques to catch up to the live edge. In one scenario, endpoint device 115 can automatically skip ahead playback or seek playback to the live edge. In another scenario, endpoint device 115 can utilize variable playback speed to speed up playback of the streaming media content corresponding to the live event until playback on endpoint device 115 catches up to the live edge. For example, endpoint device 115 can speed up playback of the buffered content until the buffer is empty and endpoint device 115 has reached the live edge of the streaming media content corresponding to the live event.

In some cases, the ad break 1106 might terminate early because playback of an ad associated with the ad break 1106 fails. In this scenario, endpoint device 115 might exhaust content for the ad break 1106 and fall back to streaming the live event. In the event that there is no backup video feed provided by the broadcaster that endpoint device 115 can stream in such an event, endpoint device 115 can add padding content, such as a black screen, a splash screen, or locally stored video that can be played until the streaming media content from the broadcaster of the live event resumes.

Referring next to FIG. 11B, shown is an alternative scenario in which an endpoint device 115 is streaming a live event behind the live edge, or on a delay. For example, a user might opt to join the stream of a live event after the event has begun. Accordingly, FIG. 11B illustrates how endpoint devices 115 handle the scenario in which an ad break ends prematurely in the event that endpoint device 115 is streaming the event behind the live edge.

In FIG. 11B, two timelines are again shown. Timeline 1102 corresponds to the actual live event, and timeline 1150 corresponds to an endpoint device 115 that is streaming the live event behind the live edge, or on a delay. In the scenario shown in FIG. 11B, endpoint device 115 or other downstream systems can receive indications, such as SCTE-35 markers, that a given ad break is commencing, ending, or being cancelled, in real time so that endpoint device 115 can proactively alter the content being played back in response. Accordingly, endpoint device 115 can proactively respond to an ad break 1106 that unexpectedly or prematurely ends due to various reasons.

The timeline 1102 shown in FIG. 11B is the same as the timeline 1102 in FIG. 11A for illustrative purposes. Timeline 1150 corresponds to an endpoint device 115 playing streaming media content corresponding to a live event, but endpoint device 115 is playing the streaming media content behind the live edge. Endpoint device 115 streams a first portion 1151 of streaming media content corresponding to the live event. Endpoint device 115 receives the indication that the ad break 1106 has commenced in the timeline 1102 of the live event. The indication can include a timestamp from which endpoint device 115 can determine when in timeline 1150 the ad break 1106 begins. In the timeline 1150 of endpoint device 115, after playing the first portion 1151, endpoint device 115 commences ad break 1153.

In the timeline 1150 of endpoint device 115, endpoint device 115 still operates by playing back prefetched ad information corresponding to ads a0 and a1. Similarly, ad a1 includes splice points s03 and s04. The splice points again represent points within a streaming video file corresponding to respective ads where video corresponding to the ads. Accordingly, upon receiving the indication that the ad break 1106 has commenced, endpoint device 115 begins playback of ads a0 and a1 when the first portion 1151 has completed playback. As shown in FIG. 11B, the ad break 1106 terminates early at timestamp 1108. At timestamp 1108, endpoint device 115 receives an indication that the ad break 1106 is cancelled or is ending prematurely. The indication can be represented by a SCTE-35 marker or message that includes the indication that the ad break 1106 is ending prematurely.

Additionally, endpoint device 115 receives the indication at timestamp 1108 that the ad break 1153 is cancelled or is ending prematurely. Therefore, endpoint device 115 determines a playback resumption point by selecting the nearest splice point, which is splice point s03, at which to splice the ad a1 and resume playback of the streaming media content corresponding to the live event. In some cases, selecting the playback resumption point causes endpoint device 115 to skip closer towards the live edge.

Because endpoint device 115 remains behind the live edge, endpoint device 115 buffers playback of the streaming media content and immediately resumes playback of the streaming media content corresponding to the live event that is stored in the buffer of endpoint device 115. Similar to the scenario shown in FIG. 11A, rather than immediately terminating playback of the ad a1 in the middle of a fragment, endpoint device 115 waits until a fragment boundary, represented by splice point s03 in the depicted example. As noted above, a client might be constrained to splicing an ad at a splice point or fragment boundary and might be unable to splice the ad outside of a fragment boundary for video encoding purposes.

In some cases, endpoint device 115 can simply remain behind the live edge and play the ad breaks for which ad information is prefetched. Endpoint device 115 can again utilize various techniques to catch up to the live edge when endpoint device 115 is behind the live edge. In one scenario, endpoint device 115 can automatically skip ahead playback or seek playback to the live edge. In another scenario, endpoint device 115 can utilize variable playback speed to speed up playback of the streaming media title corresponding to the live event until playback on endpoint device 115 catches up to the live edge. For example, endpoint device 115 can speed up playback of the buffered content until the buffer is empty and endpoint device 115 has reached the live edge of the streaming media title.

In some cases, the ad break 1153 might terminate early because playback of an ad identified by a respective manifest associated with the ad break 1153 fails. In this scenario, endpoint device 115 might exhaust content for the ad break 1153 and fall back to streaming the live event. In the event that there is no backup video feed provided by the broadcaster that endpoint device 115 can stream in such an event, endpoint device 115 can add padding content, such as a black screen, a splash screen, or locally stored video that can be played until the streaming media title corresponding to the live event resumes.

FIG. 12 is a flow diagram of method steps for handling early return scenarios, according to various embodiments. Although the method steps are described in conjunction with the systems of FIGS. 1-11B, persons skilled in the art will understand that any system configured to perform the method steps, in any order, is within the scope of the present invention.

As shown, a method 1200 begins at step 1202, where an endpoint device 115 receives an indication that an ad break is commencing. In the case of an endpoint device 115 that is at the live edge, the indication is received in real time. In the case of an endpoint device 115 that is behind the live edge, the indication of the start of an ad break is received in real time, but endpoint device 115 only commences the ad break once the timecode specified in the indication is reached in the timeline of endpoint device 115. In some embodiments, the indication of the ad break commencing comprises a SCTE-35 marker that specifies various metadata related to the ad break, such as start time and an expected duration of the ad break.

At step 1204, endpoint device 115 terminates playback of the streaming media content, which can correspond to a live event. In some cases, such as when endpoint device 115 is streaming an ad-supported SVOD title rather than a live event, endpoint device 115 pauses playback of the streaming media title for an ad break.

At step 1206, endpoint device 115 plays one or more ads based on prefetched ad information associated with the ad break. The prefetched ad information can include a list of ads that should be played during the ad break as well as one or more manifests corresponding to the ads. The manifests specify from where endpoint device 115 can retrieve or play back the ads.

At step 1208, endpoint device 115 receives an indication that the ad break is ending prematurely or being cancelled. In one embodiment, the indication comprises an ad marker such as a SCTE-35 marker embedded in a timed metadata track or event track. In some cases, the indication can specify a timestamp at which the ad break is being cancelled or prematurely ending.

At step 1210, endpoint device 115 determines a playback resumption point of the streaming media content. In one scenario, when endpoint device 115 is streaming at the live edge, endpoint device 115 selects the next or the nearest splice point in a currently playing ad as the playback resumption point. In another scenario, when endpoint device 115 is streaming behind the live edge, endpoint device 115 selects the nearest splice point in the timeline of endpoint device 115, which could be a splice point earlier in the ad break than an endpoint device 115 that is streaming at the live edge.

At step 1212, endpoint device 115 resumes playback of the streaming media content at the playback resumption point. In one scenario, when endpoint device 115 is streaming at the live edge, endpoint device 115 buffers playback of the streaming media content before terminating playback of the ad and then resumes playback of the streaming media content. Therefore, rather than immediately terminating playback of the ad in the middle of a fragment, endpoint device 115 waits until a fragment boundary, represented by a splice point. By buffering playback of the live event by buffer amount, endpoint device 115 that was streaming the streaming media content at the live edge may move behind the live edge by the buffer amount. Accordingly, endpoint device 115 can simply remain behind the live edge by the buffer amount or catch up to the live edge via seeking to the live edge or utilizing variable speed playback techniques described above. In the case of an endpoint device 115 that is streaming behind the live edge, endpoint device 115 determines a playback resumption point by selecting the nearest splice point to the timestamp of the indication that the ad break is being cancelled. The nearest splice point is a point at which to splice the ad and resume playback of the streaming media content corresponding to the live event. In some cases, selecting the playback resumption point causes endpoint device 115 to skip closer towards the live edge.

As noted above, because endpoint device 115 remains behind the live edge, endpoint device 115 buffers playback of the streaming media content and immediately resumes playback of the streaming media content corresponding to the live event that is stored in the buffer of endpoint device 115. Similar to the scenario of an endpoint device 115 that was streaming at the live edge, rather than immediately terminating playback of the ad in the middle of a fragment, endpoint device 115 waits until a fragment boundary. Endpoint device 115 behind the live edge can also skip ahead to the live edge or utilize variable playback techniques to catch up to the live edge, as described above.

Additionally, although the disclosed techniques are described relative to live streaming of live events at the live edge of a corresponding media content, persons skilled in the art will understand that any of the disclosed techniques can also be applied to other streaming configurations, including live streaming behind the live edge as well as SVOD of pre-recorded media content.

### Obtaining Ad Decisions Behind the Live Edge

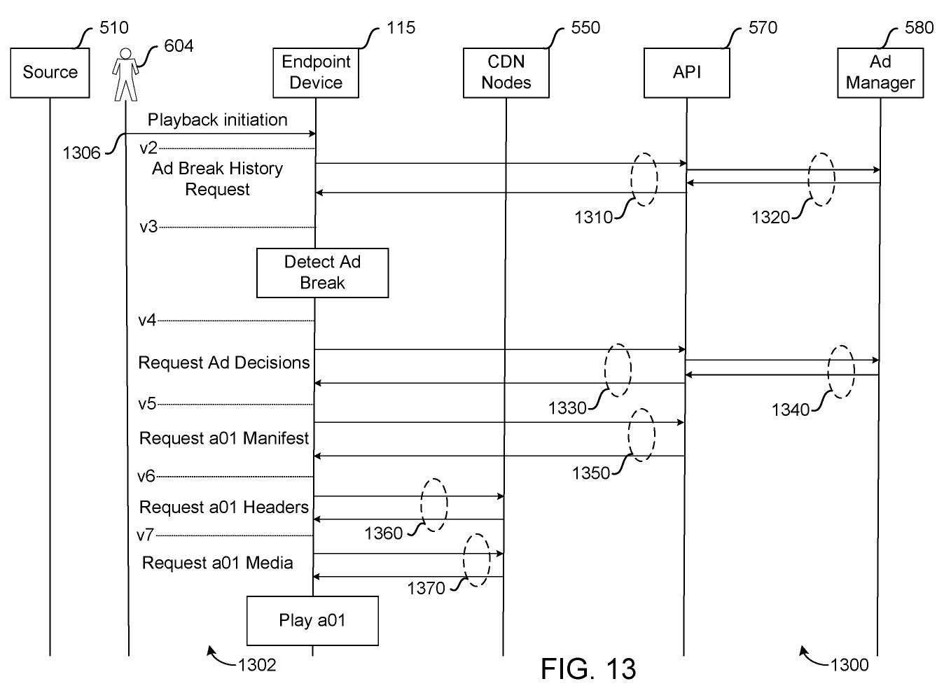

FIG. 13 is a sequence diagram 1300 of various operations that an endpoint device 115 performs to play ads during times when behind the live edge of a stream associated with streaming media content, according to various embodiments. As shown, sequence diagram 1300 also includes a source 510, an endpoint device 115, CDN nodes 550, an API 570, and an ad manager 580, configured to interact with one another via network interactions 610, 620, 630, 632, 640, 650, 660, 670, 680, and 690. Any of the network interactions discussed herein generally include both a network request and a network response that includes requested data.

In operation, endpoint device 115 performs a sequence 1302 of operations across times v1 through v6 in order to coordinate the playback of one or more ads when streaming a live event when endpoint device 115 streams the live event behind the live edge, or on a delay. Although the techniques described herein are generally applicable to live streaming sessions where the endpoint device streams behind the live edge, persons skilled in the art will recognize that the disclosed techniques can also be applied to SVOD configurations as well as any other technically feasible variety of streaming configuration.

Endpoint device 115 initiates the sequence 1302 of operations in response to receiving from a user 604 a playback initiation 1306 at time v1. For example, and without limitation, the user 604 could select a “play” button associated with a live event that is occurring in real time or that has already occurred. The playback initiation 1306 can include a request to watch the live event from the beginning or on a delay. The playback initiation 1306 can also include a request to rewind or seek to a playback point in the streaming media title that is behind the live edge. In response, at time v2, endpoint device 115 coordinates network interactions 1310 with API 570 in order to obtain an ad history associated with the streaming media title. The ad break history comprises a list of ad breaks that occurred in the live stream of the event that was streamed to one or more other endpoint devices 115. Each of the ad breaks can be identified in the list with an ad break identifier that uniquely identifies the ad break within the streaming media title. In some embodiments, the ad break history also specifies the ad break decisions for each ad break in the ad break history. The ad break history and the identifiers therein are prefetched prior to commencement of a respective ad break.

In response to receiving a request from endpoint device 115 for the ad break history, API 570 initiates network interactions 1320 to request the ad break history from ad manager 580. The ad break history identifies the ad breaks that have occurred in the stream of the streaming media title prior to the playback initiation 1306. The ad break history identifies the historical ad breaks associated with the streaming media title, and each of the ad breaks is identified with an ad break identifier. Accordingly, the API 570 provides the ad break history obtained from the ad manager 580 in network interactions 1320 in network interaction 1310.

At time v3, endpoint device 115 detects an ad break in the streaming media title. In one embodiment, a timestamp or timecode identifying a particular ad break is known based on the ad break history, which can include a timecode identifying a historical ad break along with an ad break identifier. In another embodiment, the stream of the streaming media title includes a digital marker, such as a SCTE-35 marker embedded in the stream that identifies an ad break is commencing. In one example, the digital marker includes an ad break identifier.

At time v4, endpoint device 115 initiates network interactions 1330 to request an identification of ads, or the ad decisions associated with the ad break detected at time v3. In one example, the request includes an ad break identifier associated with the ad break that was detected at time v3. As noted above, ad manager 580 determines ad decisions 582 that specify the ads played during an ad break. Additionally, the ad decisions 582 specify a type of ad break that should occur along with identifiers that indicate the particular ads that should play during a respective ad break. In various embodiments, the ad decisions 582 can be consistent across any endpoint device 115 streaming a given live event, thereby facilitating a shared user experience where all users are presented with the same ads for a given playback position. In other embodiments, the ad decisions 582 may vary between users and may be dynamically generated based on the location of endpoint device 115, user demographics, user preferences, and other dynamic information. Accordingly, ad manager 580 provides the list of ad breaks, or the ad decisions 582, to API 570 in network interactions 1340. In one embodiment, API 570 can provide all the ad decisions 582 for all the ad breaks that have occurred in the stream of the live event in the ad history provided to endpoint device 115 in connection with network interactions 1310. In the depicted example, ad manager 580 provides the ad decisions 582 for the identified ad break to API 570 to conclude network interaction 1340, and API 570 provides the ad decisions 582 to endpoint device 115 to conclude network interaction 1330.

At time v5, endpoint device 115 initiates network interactions 1350 to request a manifest for a first ad specified by the ad decisions 582. The request can include an ad break identifier as well as an identifier for the first ad that is specified by the ad decisions 582 obtained at time v4. The manifest for the first ad specifies a uniform resource locator (URL), uniform resource identifier (URI), or any other type of address from which the media corresponding to the first ad can be retrieved. The manifest can also include any other parameters, credentials, or information necessary to retrieve or playback the first ad. At time v6, endpoint device 115 initiates network interactions 1360 to retrieve one or more headers associated with the first ad a01 from CDN nodes 550. As mentioned above, ads are generally stored in the CDN nodes 550 as short media titles similar to the other media titles described herein. At time v7, endpoint device 115 initiates network interactions 1370 to retrieve the media associated with the first ad a01. Thereafter, endpoint device 115 plays back the first ad a01 for which the headers and media were retrieved from the CDN nodes 550.

When the first ad has finished playing, endpoint device 115 can discard the first ad manifest, thereby freeing memory resources for subsequent ad manifests. In some cases, the first ad manifest is discarded once the information needed to retrieve the headers and media for the first ad a01 are stored by endpoint device 115. Endpoint device 115 can then subsequently retrieve the manifest for a second or subsequent ad. In some embodiments, as described above, endpoint device 115 can prefetch a second or subsequent ad manifest during playback of the first ad so that endpoint device 115 has already stored a second ad manifest for the second ad. In some situations, endpoint device 115 may have prefetched the second ad manifest well in advance and prior to playback of the first ad a01. In other embodiments, endpoint device 115 may have fetched the second ad manifest during playback of the first ad a01.

Endpoint device 115 can then begin streaming a media title corresponding to the second ad via network interactions similar to network interactions 1360 and 1370 with the CDN nodes 550. In particular, endpoint device 115 uses the URLs included in the second ad manifest to request and then subsequently display segments of audiovisual content associated with the second ad. When the second ad manifest is no longer needed, endpoint device 115 can discard the second ad manifest, thereby freeing memory resources for subsequent ad manifests. In conjunction with these operations, endpoint device 115 may also fetch additional ad manifests in order to prepare for the playback of subsequent ads. When playback of the second ad completes, endpoint device 115 can then play additional ads based on any additional ad manifests or, alternatively, if the ad break is complete, return to streaming the live event.

In some implementations, rather than playing the same ads specified by the ad decisions 582 that are utilized at the live edge, endpoint device 115 can play ads that are personalized to a user associated with endpoint device 115. Accordingly, endpoint device 115 can play another ad rather than the first ad and/or discard the first ad to retrieve a second ad that is different from the first ad.

Via the sequence of operations 1302 described above, endpoint device 115 can stream a live event while behind the live edge and then temporarily suspend playback of the live event during an ad break in order to stream one or more media titles corresponding to one or more ads. Furthermore, the sequence of operations 1302 addresses technical issues that can arise in conventional streaming platforms when vast numbers of clients simultaneously stream a given media title behind the live edge. In particular, a consistent experience is provided for users streaming the live event while behind the live edge and while at the live edge, which can be desired or useful for large-scale events where a consistent ad experience is desired or required by a broadcaster of the event.

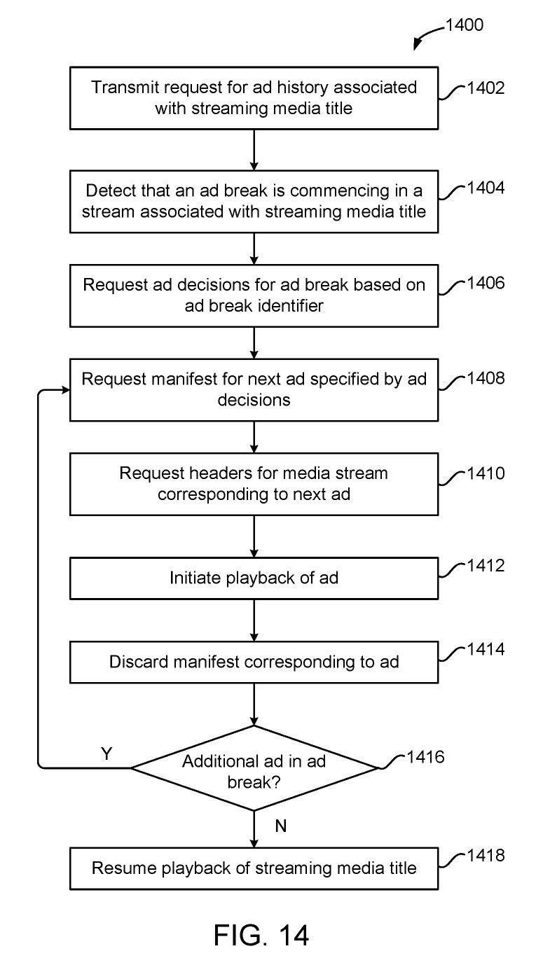

FIG. 14 is a flow diagram of method steps for handling early return scenarios, according to various embodiments. Although the method steps are described in conjunction with the systems of FIGS. 1-13, persons skilled in the art will understand that any system configured to perform the method steps, in any order, is within the scope of the present invention.

As shown, a method 1400 begins at step 1402, where endpoint device 115 transmits a request to retrieve an ad history associated with streaming media content that is being streamed by the endpoint device 115. As noted above, the ad break history comprises a list of ad breaks that occurred in the live stream of the event that was streamed to one or more other endpoint devices 115. Each of the ad breaks can be identified in the list with an ad break identifier. In some embodiments, the ad break history also specifies the ad break decisions for each ad break in the ad break history.

At step 1404, endpoint device 115 detects that an ad break in the stream associated with the streaming media content is commencing. For an endpoint device 115 that is behind the live edge, the indication of the start of an ad break is received in real time, but endpoint device 115 only commences the ad break once the timecode specified in the indication is reached in the timeline of endpoint device 115. In some embodiments, the indication of the ad break commencing comprises a SCTE-35 marker that specifies various metadata related to the ad break, such as start time and an expected duration of the ad break.

At step 1406, endpoint device 115 requests ad decisions associated with the ad break detected at step 1404. The ad decisions are requested by transmitting a request that includes an ad break identifier from the ad break history to the API 570, which retrieves the ad decisions for the ad break from ad manager 580. In some embodiments, endpoint device 115 prefetches the ad decisions prior to the commencement of the ad break.

At step 1408, endpoint device 115 requests an ad manifest 592 for the first ad specified by the ad decisions 582. The ad manifest 592 for the first ad specifies a uniform resource locator (URL), uniform resource identifier (URI), or any other type of address from which the media corresponding to the first ad can be retrieved. The manifest can also include any other parameters, credentials, or information necessary to retrieve or playback the first ad.

At step 1410, endpoint device 115 requests headers for the media stream corresponding to the first ad. Accessing the ad headers in this manner causes the CDN nodes 550 to pre-load any media titles associated with those ad headers, thereby pre-caching these media titles or “warming” the CDN where the CDN nodes 550 reside.

At step 1412, endpoint device 115 can play back the ad associated with the first ad break. At step 1414, endpoint device 115 can discard the first ad manifest, thereby freeing memory resources for subsequent ad manifests. As noted above, in some cases, the first ad manifest is discarded once the information needed to retrieve the headers and media for the first ad is stored by endpoint device 115. Then, at step 1416, endpoint device 115 determines whether there are subsequent ads associated with the ad break. If additional ads are present, method 1400 returns to step 1408, where the endpoint device 115 retrieves a manifest, headers, and media associated with a next ad in the break. Otherwise, method 1400 proceeds to step 1418, where endpoint device 115 resumes playback of the streaming media content behind the live edge.

In sum, an endpoint device is configured to stream audiovisual content associated with media titles that correspond to a live event occurring in real time. During live streaming, the endpoint device can transition from streaming primary audiovisual content associated with the live event to streaming secondary content associated with one or more advertisements (ads) during a pre-planned or spontaneous ad break. The endpoint device streams the media title using a playback manifest that describes how and where to obtain the corresponding audiovisual content. The playback manifest also describes a prefetch window within which the endpoint device can prefetch ad information associated with an upcoming ad break.

When the prefetch window arrives, the endpoint device computes a prefetch time at which to prefetch the ad information. The prefetch time can be computed randomly or selected based on the memory capacity of the endpoint device. When the prefetch time arrives, the endpoint device prefetches ad decisions that describe specific ads that should play during the ad break. Based on the ad decisions, the endpoint device then prefetches one or more ad manifests that describe how and where to obtain audiovisual content associated with the corresponding ads. When the ad break commences, the endpoint device plays the relevant ads using the relevant ad manifests, and then fetches additional ad manifests as needed based on an amount of available memory resources. In some cases, the endpoint device also prefetches ad information, including ad decisions and ad manifests, associated with multiple alternative ad breaks that could be selected to commence. Upon receipt of an ad marker indicating a specific selection of ad break, the endpoint device discards any unneeded ad manifests and fetches additional ad manifests associated with the selected ad break. When the ad break arrives, the endpoint device plays the relevant ads based on the prefetched ad manifests.

An endpoint device is also configured to stream audiovisual content associated with media content that corresponds to a live event occurring in real time. During live streaming, the endpoint device can transition from streaming primary audiovisual content associated with the live event to streaming secondary content associated with one or more ads during a pre-planned or spontaneous ad break. If the ad break ends prematurely or unexpectedly, the endpoint device can resume streaming the content by selecting a playback resumption point and terminating playback of one or more ads scheduled for an ad break. The playback resumption point is selected based on splice points in the ads for which information is prefetched by the endpoint device.

An endpoint device is further configured to stream audiovisual content associated with a live event from behind the live edge. During live streaming, the endpoint device can transition from streaming primary audiovisual content associated with the live event to streaming secondary content associated with one or more ads during a pre-planned or spontaneous ad break. When the endpoint device is behind the live edge, an ad break history is retrieved along with the historical ad decisions. In this way, a consistent ad experience is provided to the user while utilizing a framework that also supports dynamically inserted or personalized ads into a content stream.

At least one technical advantage of the disclosed techniques relative to the prior art is that the disclosed techniques enable endpoint devices to distribute requests for ad information across a time interval. Such a distribution minimizes large traffic spikes and helps prevent an ad manager from becoming overwhelmed when servicing such requests. Another technical advantage of the disclosed techniques is that the disclosed techniques enable endpoint devices to prefetch ad information for multiple alternative ad breaks. Such prefetching minimizes large traffic spikes that can occur in response to unforeseen ad breaks and further protects the ad manager from becoming overwhelmed when servicing requests for ad information. The technical advantages provide one or more technical advancements over the prior art.

At least one technical advantage of the disclosed techniques relative to the prior art is that the disclosed techniques enable endpoint devices to rejoin a live stream without the viewer missing any content at the live edge. The disclosed techniques identify a splice point at which playback of an ad or an ad break can be terminated and at which playback of the live event can be resumed. Such an approach results in a smoother playback experience for the user because frames corresponding to the ad and frames corresponding to the streaming media title are not dropped or missed. Additionally, when the endpoint device is behind the live edge as a result of resuming playback of the live event behind the live edge, the disclosed techniques can utilize various measures to catch up the endpoint device to the live edge.

Another technical advantage of the disclosed techniques relative to the prior art is that the disclosed techniques enable endpoint devices to receive a consistent ad experience regardless of whether respective endpoint devices are joining a live event at the live edge or before the live edge. Such an approach also minimizes traffic spikes and prevents the ad manager from being overwhelmed when servicing requests for ad information from various endpoint devices that are receiving a streaming media title. Yet another technical advantage of the disclosed techniques is that the disclosed techniques enable endpoint devices to be served the same or varying ad experiences based on where respective endpoint devices join a respective stream.

These technical advantages provide one or more technological advancements over prior art approaches.
1. Some embodiments include a computer-implemented method for prefetching auxiliary audiovisual content information associated with an upcoming auxiliary audiovisual content break when streaming primary audiovisual content associated with a media title, the method comprising determining that a prefetch window has been reached during streaming of the primary audiovisual content, determining a prefetch time within the prefetch window based on at least one parameter, prefetching, at the prefetch time, the auxiliary audiovisual content information, and causing at least a portion of the auxiliary audiovisual content to be played during the upcoming auxiliary audiovisual content break based at least on the auxiliary audiovisual content information.
2. The computer-implemented method of clause 1, wherein the at least one parameter comprises a randomized value, and the prefetch time comprises a randomized time within the prefetch window.
3. The computer-implemented method of any of clauses 1-2, wherein determining the prefetch time within the prefetch window occurs before determining that the prefetch window has been reached..
4. The computer-implemented method of any of clauses 1-3, further comprising parsing a playback manifest to identify the prefetch window, wherein the playback manifest indicates playback information associated with the media title.
5. The computer-implemented method of any of clauses 1-4, further comprising parsing previous auxiliary audiovisual content information to identify the prefetch window, wherein the previous auxiliary audiovisual content information corresponds to previously played auxiliary audiovisual content.
6. The computer-implemented method of any of clauses 1-5, further comprising parsing a manifest to determine an offset and a duration associated with the prefetch window, wherein determining that the prefetch window has been reached occurs based on the offset, and determining the prefetch time occurs based on the offset and/or the duration.
7. The computer-implemented method of any of clauses 1-6, further comprising fetching additional auxiliary audiovisual content information associated with a subsequent auxiliary audiovisual content break while playing the auxiliary audiovisual content.
8. The computer-implemented method of any of clauses 1-7, wherein the auxiliary audiovisual content information includes a set of auxiliary audiovisual content decisions that identify the auxiliary audiovisual content and/or a set of auxiliary audiovisual content manifests that include playback information associated with the auxiliary audiovisual content.
9. The computer-implemented method of any of clauses 1-8, further comprising parsing the auxiliary audiovisual content information to determine a subsequent prefetch window associated with a subsequent auxiliary audiovisual content break.
10. The computer-implemented method of any of clauses 1-9, further comprising receiving an auxiliary audiovisual content marker that identifies the upcoming auxiliary audiovisual content break, wherein playing the auxiliary audiovisual content during the upcoming auxiliary audiovisual content break occurs based on the auxiliary audiovisual content marker.
11. Some embodiments include one or more non-transitory computer-readable media including instructions that, when executed by one or more processors, cause the one or more processors to prefetch auxiliary audiovisual content information associated with an upcoming auxiliary audiovisual content break when streaming primary audiovisual content associated with a media title by performing the steps of determining that a prefetch window has been reached during streaming of the primary audiovisual content, determining a prefetch time within the prefetch window based on at least one parameter, prefetching, at the prefetch time, the auxiliary audiovisual content information, and causing the auxiliary audiovisual content to be played during the upcoming auxiliary audiovisual content break based at least on the auxiliary audiovisual content information.
12. The one or more non-transitory computer-readable media of clause 11, wherein the at least one parameter comprises a randomized value, and the prefetch time comprises a randomized time within the prefetch window.
13. The one or more non-transitory computer-readable media of any of clauses 11-12, wherein the step of determining the prefetch time within the prefetch window occurs before the step of determining that the prefetch window has been reached.
14. The one or more non-transitory computer-readable media of any of clauses 11-13, further comprising the step of parsing a playback manifest to identify the prefetch window, wherein the playback manifest indicates playback information associated with the media title.
15. The one or more non-transitory computer-readable media of any of clauses 11-14, further comprising the step of parsing previous auxiliary audiovisual content information to identify the prefetch window, wherein the previous auxiliary audiovisual content information corresponds to previously played auxiliary audiovisual content.
16. The one or more non-transitory computer-readable media of any of clauses 11-15, further comprising the step of parsing a manifest to determine an offset and a duration associated with the prefetch window, wherein the step of determining that the prefetch window has been reached occurs based on the offset, and the step of determining the prefetch time occurs based on the offset and/or the duration.
17. The one or more non-transitory computer-readable media of any of clauses 11-16, wherein the media title corresponds to a live event occurring in real time, and wherein the step of streaming the primary audiovisual content occurs at a live edge of the media title.
18. The one or more non-transitory computer-readable media of any of clauses 11-17, wherein the step of prefetching the auxiliary audiovisual content information comprises determining an operational attribute of an endpoint device that streams the primary audiovisual content , and determining an amount of auxiliary audiovisual content information to prefetch based on the operational attribute of the endpoint device.
19. The one or more non-transitory computer-readable media of any of clauses 11-18, wherein an endpoint device determines the prefetch time, and the prefetch time occurs earlier in the prefetch window than another prefetch time associated with another endpoint device that has greater operational constraints compared to the endpoint device.
20. Some embodiments include a system comprising one or more memories storing instructions, and one or more processors coupled to the one or more memories that, when executing the instructions, perform the steps of determining that a prefetch window has been reached during streaming of primary audiovisual content associated with a media title, determining a prefetch time within the prefetch window based on at least one parameter, prefetching, at the prefetch time, auxiliary audiovisual content information associated with an upcoming auxiliary audiovisual content break, and causing auxiliary audiovisual content to be played during the upcoming auxiliary audiovisual content break based at least on the auxiliary audiovisual content information.
21. Some embodiments include a computer-implemented method for prefetching alternative auxiliary audiovisual content information associated with alternative auxiliary audiovisual content breaks when streaming primary audiovisual content associated with a media title, the method comprising determining that a prefetch time has been reached during streaming of the primary audiovisual content, prefetching alternative sets of auxiliary audiovisual content information corresponding to the alternative auxiliary audiovisual content breaks, determining that a first auxiliary audiovisual content break included in the alternative auxiliary audiovisual content breaks should occur, identifying first auxiliary audiovisual content information included in the alternative sets of auxiliary audiovisual content information that corresponds to the first auxiliary audiovisual content break, and playing auxiliary audiovisual content during the first auxiliary audiovisual content break based on the first auxiliary audiovisual content information.
22. The computer-implemented method of clause 21, wherein prefetching the alternative sets of auxiliary audiovisual content information comprises prefetching alternative sets of auxiliary audiovisual content decisions, wherein a given set of auxiliary audiovisual content decisions identifies one or more portions of auxiliary audiovisual content associated with a corresponding alternative auxiliary audiovisual content break, and prefetching at least one auxiliary audiovisual content manifest for each set of auxiliary audiovisual content decisions, wherein a given auxiliary audiovisual content manifest includes playback information associated with at least one portion of auxiliary audiovisual content.
23. The computer-implemented method of any of clauses 21-22, wherein determining that the first auxiliary audiovisual content break should occur comprises receiving an auxiliary audiovisual content marker that identifies the first auxiliary audiovisual content break when streaming the primary audiovisual content.
24. The computer-implemented method of any of clauses 21-23, further comprising, in response to determining that the first auxiliary audiovisual content break should occur, discarding second auxiliary audiovisual content information corresponding to a second auxiliary audiovisual content break included in the alternative auxiliary audiovisual content breaks.
25. The computer-implemented method of any of clauses 21-24, further comprising, in response to determining that the first auxiliary audiovisual content break should occur, prefetching additional auxiliary audiovisual content information corresponding to the first auxiliary audiovisual content break.
26. The computer-implemented method of any of clauses 21-25, further comprising fetching additional auxiliary audiovisual content information associated with the auxiliary audiovisual content while playing a first portion of auxiliary audiovisual content included in the auxiliary audiovisual content.
27. The computer-implemented method of any of clauses 21-26, wherein prefetching the alternative sets of auxiliary audiovisual content information occurs based on at least one operational attribute associated with an endpoint device that streams the primary audiovisual content.
28. The computer-implemented method of any of clauses 21-27, wherein determining that the prefetch time has arrived comprises computing a random time within a prefetch window that occurs before the first auxiliary audiovisual content break.
29. The computer-implemented method of any of clauses 21-28, further comprising determining a prefetch window based on a playback manifest associated with the media title, and determining the prefetch time within the prefetch window based on at least one parameter associated with an endpoint device that streams the media title.
30. The computer-implemented method of any of clauses 21-29, further comprising determining a prefetch window based on previous auxiliary audiovisual content information associated with previously displayed auxiliary audiovisual content, and determining the prefetch time within the prefetch window based on at least one parameter associated with an endpoint device that streams the primary audiovisual content.
31. Some embodiments include one or more non-transitory computer-readable media including instructions that, when executed by one or more processors, cause the one or more processors to prefetch alternative auxiliary audiovisual content information associated with alternative auxiliary audiovisual content breaks when streaming primary audiovisual content associated with a media title by performing the steps of determining that a prefetch time has been reached during streaming of the primary audiovisual content, prefetching alternative sets of auxiliary audiovisual content information corresponding to the alternative auxiliary audiovisual content breaks, determining that a first auxiliary audiovisual content break included in the alternative auxiliary audiovisual content breaks should occur, identifying first auxiliary audiovisual content information included in the alternative sets of auxiliary audiovisual content information that corresponds to the first auxiliary audiovisual content break, and playing auxiliary audiovisual content during the first auxiliary audiovisual content break based on the first auxiliary audiovisual content information.
32. The one or more non-transitory computer-readable media of clause 31, wherein the step of prefetching the alternative sets of auxiliary audiovisual content information comprises prefetching alternative sets of auxiliary audiovisual content decisions, wherein a given set of auxiliary audiovisual content decisions identifies one or more portions of auxiliary audiovisual content associated with a corresponding alternative auxiliary audiovisual content break, and prefetching at least one auxiliary audiovisual content manifest for each set of auxiliary audiovisual content decisions, wherein a given auxiliary audiovisual content manifest includes playback information associated with at least one portion of auxiliary audiovisual content.
33. The one or more non-transitory computer-readable media of any of clauses 31-32, wherein the step of determining that the first auxiliary audiovisual content break should occur comprises receiving an auxiliary audiovisual content marker that identifies the first auxiliary audiovisual content break when streaming the primary audiovisual content.
34. The one or more non-transitory computer-readable media of any of clauses 31-33, further comprising the step of, in response to determining that the first auxiliary audiovisual content break should occur, discarding second auxiliary audiovisual content information corresponding to a second auxiliary audiovisual content break included in the alternative auxiliary audiovisual content breaks.
35. The one or more non-transitory computer-readable media of any of clauses 31-34, further comprising the step of, in response to determining that the first auxiliary audiovisual content break should occur, prefetching additional auxiliary audiovisual content information corresponding to the first auxiliary audiovisual content break.
36. The one or more non-transitory computer-readable media of any of clauses 31-35, further comprising the step of fetching additional auxiliary audiovisual content information associated with the auxiliary audiovisual content while playing a first portion of auxiliary audiovisual content included in the auxiliary audiovisual content.
37. The one or more non-transitory computer-readable media of any of clauses 31-36, wherein a given set of alternative auxiliary audiovisual content decisions includes a first set of auxiliary audiovisual content decisions corresponding to a first sequence of auxiliary audiovisual content portions and a second set of auxiliary audiovisual content decisions corresponding to a second sequence of auxiliary audiovisual content portions.
38. The one or more non-transitory computer-readable media of any of clauses 31-37, wherein the alternative auxiliary audiovisual content breaks correspond to sequences of auxiliary audiovisual content portions that have not yet been played during streaming of the media title.
39. The one or more non-transitory computer-readable media of any of clauses 31-38, wherein the media title corresponds to a live event occurring in real time, and wherein streaming the primary audiovisual content associated with the media title occurs at a live edge of the media title.
40. Some embodiments include a system comprising one or more memories storing instructions, and one or more processors coupled to the one or more memories that, when executing the instructions, perform the steps of determining that a prefetch time has been reached during streaming of primary audiovisual content associated with a media title, prefetching alternative sets of auxiliary audiovisual content information corresponding to alternative auxiliary audiovisual content breaks, determining that a first auxiliary audiovisual content break included in the alternative auxiliary audiovisual content breaks should occur, identifying first auxiliary audiovisual content information included in the alternative sets of auxiliary audiovisual content information that corresponds to the first auxiliary audiovisual content break, and playing auxiliary audiovisual content during the first auxiliary audiovisual content break based on the first auxiliary audiovisual content information.
41. In some embodiments, a computer-implemented method for playback of auxiliary media content associated with auxiliary media content breaks when streaming media content comprises identifying an upcoming auxiliary media content break based on auxiliary media content information prefetched prior to the auxiliary media content break, terminating playback of streaming media content at a specified time based on the auxiliary media content information, playing back one or more auxiliary media content items specified by the ad information, receiving a second indication that the auxiliary media content break is ending an unexpected time, the unexpected time being prior to a scheduled time, determining a playback resumption point based on the second indication and the one or more auxiliary media content items, and resuming playback of the streaming media content at the playback resumption point.
42. The computer-implemented method of any of clauses 1-41, wherein determining the playback resumption point comprises determining a splice point of a currently playing auxiliary media content item from the one or more auxiliary media content items.
43. The computer-implemented method of any of clauses 1-42, further comprising buffering playback of the streaming media content until the splice point of the currently playing auxiliary media content item from the one or more auxiliary media content items is reached.
44. The computer-implemented method of any of clauses 1-42, wherein resuming playback of the streaming media content at the playback resumption point further comprises ending playback of the currently playing auxiliary media content item from the one or more auxiliary media content items at the splice point.
45. The computer-implemented method of any of clauses 1-41, wherein the unexpected end time comprises an early return to the streaming media content prior to expiration of the auxiliary media content break according to the ad information.
46. The computer-implemented method of any of clauses 1-41, wherein the second indication comprises a digital marker indicating a cancellation of the auxiliary media content break.
47. The computer-implemented method of any of clauses 1-41, wherein the streaming media content corresponds to a live event occurring in real time.
48. The computer-implemented method of any of clauses 1-47, further comprising determining that playback of the streaming media content is behind a live edge of the live event, and determining the playback resumption point by resuming playback of the streaming media content prior to completion of the auxiliary media content break.
49. The computer-implemented method of any of clauses 1-8, wherein resuming playback of the streaming media content prior to completion of the auxiliary media content break comprises skipping playback of the one or more auxiliary media content items specified by the ad information.
50. The computer-implemented method of any of clauses 1-49, wherein resuming playback of the streaming media content prior to completion of the ad break comprises resuming playback of the streaming media content at a splice point prior to an ending of the one or more auxiliary media content items specified by the ad information.
51. The computer-implemented method of any of clauses 1-49, wherein resuming playback of the streaming media content prior to completion of the auxiliary media content break causes playback of the streaming media content to move closer to the live edge than when the auxiliary media content break began.
52. In some embodiments, one or more non-transitory computer-readable media include instructions that, when executed by one or more processors, cause the one or more processors to perform playback of auxiliary media content associated with auxiliary media content breaks when streaming media content by performing the steps of identifying an upcoming auxiliary media content break based on auxiliary media content information prefetched prior to the auxiliary media content break, terminating playback of streaming media content at a specified time based on the auxiliary media content information, playing back one or more auxiliary media content items specified by the ad information, receiving a second indication that the auxiliary media content break is ending at an unexpected time, the unexpected time being prior to a scheduled time, determining a playback resumption point based on the second indication and the one or more auxiliary media content items, and resuming playback of the streaming media content at the playback resumption point.
53. The one or more non-transitory computer-readable media of claim 52, wherein the steps further comprise determining that playback of the streaming media content is at a live edge of a live event, wherein determining the playback resumption point comprises determining a splice point of a currently playing auxiliary media content item of the one or more auxiliary media content items, wherein the splice point is after the unexpected end time, buffering playback of the streaming media content until the splice point of the currently playing auxiliary media content item of the one or more auxiliary media content items is reached, and skipping playback of the streaming media content forward after resuming playback of the streaming media content at the playback resumption point.
54. The one or more non-transitory computer-readable media of claim 52, wherein the steps further comprise determining that playback of the streaming media content is at a live edge of a live event, wherein determining the playback resumption point comprises determining a splice point of a currently playing auxiliary media content item of the one or more auxiliary media content items, wherein the splice point is after the unexpected end time, buffering playback of the streaming media content until the splice point of the currently playing auxiliary media content item of the one or more auxiliary media content items is reached, and speeding playback of the streaming media content after resuming playback of the streaming media content at the playback resumption point until playback reaches the live edge of the live event.
55. The one or more non-transitory computer-readable media of claim 54, wherein speeding playback of the streaming media content comprises modifying a playback speed of the streaming media content by a variable amount until the live edge is reached.
56. The one or more non-transitory computer-readable media of claim 52, wherein determining the playback resumption point comprises determining a splice point of a currently playing auxiliary media content item of the one or more auxiliary media content items.
57. The one or more non-transitory computer-readable media of claim 56, wherein the steps further comprise buffering playback of the streaming media content until the splice point of the currently playing auxiliary media content item is reached.
58. The one or more non-transitory computer-readable media of claim 52, wherein the unexpected end time comprises an early return to the streaming media content prior to expiration of the auxiliary media content break according to the auxiliary media content information.
59. The one or more non-transitory computer-readable media of any of clauses 1-8, wherein the second indication comprises a digital marker indicating cancellation of the auxiliary media content break.
60. In some embodiments, a system comprising one or more memories storing instructions, and one or more processors coupled to the one or more memories that, when executing the instructions, perform the steps of identifying an upcoming auxiliary media content break based on auxiliary media content information prefetched prior to the auxiliary media content break, terminating playback of streaming media content at a specified time based on the auxiliary media content information, playing back one or more auxiliary media content items specified by the ad information, receiving a second indication that the auxiliary media content break is ending at an unexpected time, the unexpected time being prior to a scheduled time, determining a playback resumption point based on the second indication and the one or more auxiliary media content items, and resuming playback of the streaming media content at the playback resumption point.
61. In some embodiments, a computer-implemented method for playback of auxiliary media content associated with auxiliary media content breaks when streaming media content comprises transmitting a request for an auxiliary media content break history associated with streaming media content, determining, based on an identifier in the auxiliary media content break history, that an auxiliary media content break associated with the streaming media content is commencing, retrieving an identification of auxiliary media content items associated with the auxiliary media content break based on the identifier, retrieving a first manifest corresponding to a first auxiliary media content item specified by the identification of auxiliary media content items, requesting a first media file associated with the first auxiliary media content items based on the first manifest, and playing the first media file associated with the first auxiliary media content item.
62. The computer-implemented method of claim 61, further comprising requesting a second manifest corresponding to a second auxiliary media content item, wherein the second manifest is requested during playback of the first auxiliary media content item.
63. The computer-implemented method of claim 62, further comprising discarding the first manifest prior to requesting the second manifest corresponding to the second auxiliary media content item.
64. The computer-implemented method of claim 61, wherein the first manifest comprises a uniform resource identifier (URI) or a uniform resource locator (URL) at which the first media file is accessible.
65. The computer-implemented method of claim 61, wherein the first auxiliary media content item is dynamically determined based upon at least one property associated with an endpoint device requesting the first manifest.
66. The computer-implemented method of claim 61, wherein the identifier uniquely identifies the auxiliary media content break within the streaming media content.
67. The computer-implemented method of claim 61, wherein detecting that the auxiliary media content break is commencing comprises identifying a digital marker in the streaming media content indicating a beginning of the ad break.
68. The computer-implemented method of claim 61, wherein detecting that the auxiliary media content break is commencing is based on the auxiliary media content break history, the auxiliary media content break history specifying a timestamp within a stream associated with the streaming media content that corresponds to the auxiliary media content break.
69. The computer-implemented method of any of clauses 1-8, further comprising identifying the first auxiliary media content item in the identification of auxiliary media content items based on the identifier.
70. The computer-implemented method of claim 61, further comprising determining that playback of the streaming media content is behind a live edge associated with the streaming media content, requesting an ad decision history, wherein the ad decision history specifies the identification of auxiliary media content items corresponding to the auxiliary media content break, identifying the first auxiliary media content in the auxiliary media content decision history based on the identifier, and playing back a second auxiliary media content item instead of the first auxiliary media content item, wherein the second auxiliary media content item is different from the first auxiliary media content item.
71. The computer-implemented method of claim 61, further comprising resuming playback of the streaming media content after playback of a plurality of auxiliary media content items specified by the identification of auxiliary media content items.
72. In some embodiments, one or more non-transitory computer-readable media include instructions that, when executed by one or more processors, cause the one or more processors to perform playback of auxiliary media content associated with auxiliary media content breaks when streaming media content by performing the steps of transmitting a request for an auxiliary media content break history associated with streaming media content, determining, based on an identifier in the auxiliary media content break history, that an auxiliary media content break associated with the streaming media content is commencing, retrieving an identification of auxiliary media content items associated with the auxiliary media content break based on the identifier, retrieving a first manifest corresponding to a first auxiliary media content item specified by the identification of auxiliary media content items, requesting a first media file associated with the first auxiliary media content items based on the first manifest, and playing the first media file associated with the first auxiliary media content item.
73. The one or more non-transitory computer-readable media of claim 72, wherein the steps further comprise determining that playback of the streaming media content is at a live edge associated with the streaming media content, and wherein the first manifest corresponding to the first auxiliary media content item is prefetched prior to detecting that the auxiliary media content break is commencing.
74. The one or more non-transitory computer-readable media of claim 72, wherein the steps further comprise requesting a second manifest corresponding to a second auxiliary media content item, wherein the second manifest is requested during playback of the first auxiliary media content item.
75. The one or more non-transitory computer-readable media of claim 74, wherein the steps further comprise discarding the first manifest prior to requesting the second manifest corresponding to the second auxiliary media content item.
76. The one or more non-transitory computer-readable media of claim 72, wherein the first manifest comprises a uniform resource identifier (URI) or a uniform resource locator (URL) at which the first media file is accessible.
77. The one or more non-transitory computer-readable media of claim 72, wherein the first auxiliary media content item is dynamically determined based upon at least one property associated with an endpoint device requesting the first manifest.
78. The one or more non-transitory computer-readable media of claim 72, wherein detecting that the auxiliary media content break is commencing comprises identifying a digital marker in the streaming media content indicating a beginning of the auxiliary media content break.
79. The one or more non-transitory computer-readable media of any of clauses 1-8, wherein detecting that the auxiliary media content break is commencing is based on the auxiliary media content break history, the auxiliary media content break history specifying a timestamp within a stream associated with the streaming media content that corresponds to the auxiliary media content break.
80. In some embodiments, a system comprising one or more memories storing instructions, and one or more processors coupled to the one or more memories that, when executing the instructions, perform the steps of transmitting a request for an auxiliary media content break history associated with streaming media content, determining, based on an identifier in the auxiliary media content break history, that an auxiliary media content break associated with the streaming media content is commencing, retrieving an identification of auxiliary media content items associated with the auxiliary media content break based on the identifier, retrieving a first manifest corresponding to a first auxiliary media content item specified by the identification of auxiliary media content items, requesting a first media file associated with the first auxiliary media content items based on the first manifest, and playing the first media file associated with the first auxiliary media content item.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for prefetching auxiliary media content information associated with an upcoming auxiliary media content break when streaming primary audiovisual content associated with a media title, the method comprising:
determining that a prefetch window has been reached during streaming of the primary audiovisual content;
determining a prefetch time within the prefetch window based on at least one parameter;
prefetching, at the prefetch time, the auxiliary media content information; and
causing at least a portion of the auxiliary media content to be played during the upcoming auxiliary media content break based at least on the auxiliary media content information.

2. The computer-implemented method of claim 1, wherein the at least one parameter comprises a randomized value, and the prefetch time comprises a randomized time within the prefetch window.

3. The computer-implemented method of claim 1, wherein determining the prefetch time within the prefetch window occurs before determining that the prefetch window has been reached.

4. The computer-implemented method of claim 1, further comprising parsing a playback manifest to identify the prefetch window, wherein the playback manifest indicates playback information associated with the media title.

5. The computer-implemented method of claim 1, further comprising parsing previous auxiliary media content information to identify the prefetch window, wherein the previous auxiliary media content information corresponds to previously played auxiliary media content.

6. The computer-implemented method of claim 1, further comprising parsing a manifest to determine an offset and a duration associated with the prefetch window, wherein determining that the prefetch window has been reached occurs based on the offset, and determining the prefetch time occurs based on the offset and/or the duration.

7. The computer-implemented method of claim 1, further comprising fetching additional auxiliary media content information associated with a subsequent auxiliary media content break while playing the auxiliary media content.

8. The computer-implemented method of claim 1, wherein the auxiliary media content information includes a set of auxiliary media content decisions that identify the auxiliary media content and/or a set of auxiliary media content manifests that include playback information associated with the auxiliary media content.

9. The computer-implemented method of claim 1, further comprising parsing the auxiliary media content information to determine a subsequent prefetch window associated with a subsequent auxiliary media content break.

10. The computer-implemented method of claim 1, further comprising receiving an auxiliary media content marker that identifies the upcoming auxiliary media content break, wherein playing the auxiliary media content during the upcoming auxiliary media content break occurs based on the auxiliary media content marker.

11. One or more non-transitory computer-readable media including instructions that, when executed by one or more processors, cause the one or more processors to prefetch auxiliary media content information associated with an upcoming auxiliary media content break when streaming primary audiovisual content associated with a media title by performing the steps of:
determining that a prefetch window has been reached during streaming of the primary audiovisual content;
determining a prefetch time within the prefetch window based on at least one parameter;
prefetching, at the prefetch time, the auxiliary media content information; and
causing the auxiliary media content to be played during the upcoming auxiliary media content break based at least on the auxiliary media content information.

12. The one or more non-transitory computer-readable media of claim 11, wherein the at least one parameter comprises a randomized value, and the prefetch time comprises a randomized time within the prefetch window.

13. The one or more non-transitory computer-readable media of claim 11, wherein the step of determining the prefetch time within the prefetch window occurs before the step of determining that the prefetch window has been reached.

14. The one or more non-transitory computer-readable media of claim 11, further comprising the step of parsing a playback manifest to identify the prefetch window, wherein the playback manifest indicates playback information associated with the media title.

15. The one or more non-transitory computer-readable media of claim 11, further comprising the step of parsing previous auxiliary media content information to identify the prefetch window, wherein the previous auxiliary media content information corresponds to previously played auxiliary media content.

16. The one or more non-transitory computer-readable media of claim 11, further comprising the step of parsing a manifest to determine an offset and a duration associated with the prefetch window, wherein the step of determining that the prefetch window has been reached occurs based on the offset, and the step of determining the prefetch time occurs based on the offset and/or the duration.

17. The one or more non-transitory computer-readable media of claim 11, wherein the media title corresponds to a live event occurring in real time, and wherein the step of streaming the primary audiovisual content occurs at a live edge of the media title.

18. The one or more non-transitory computer-readable media of claim 11, wherein the step of prefetching the auxiliary media content information comprises:
determining an operational attribute of an endpoint device that streams the primary audiovisual content; and
determining an amount of auxiliary media content information to prefetch based on the operational attribute of the endpoint device.

19. The one or more non-transitory computer-readable media of claim 11, wherein an endpoint device determines the prefetch time, and the prefetch time occurs earlier in the prefetch window than another prefetch time associated with another endpoint device that has greater operational constraints compared to the endpoint device.

20. A system comprising:
one or more memories storing instructions; and
one or more processors coupled to the one or more memories that, when executing the instructions, perform the steps of:
determining that a prefetch window has been reached during streaming of primary audiovisual content associated with a media title,
determining a prefetch time within the prefetch window based on at least one parameter,
prefetching, at the prefetch time, auxiliary media content information associated with an upcoming auxiliary media content break, and
causing auxiliary media content to be played during the upcoming auxiliary media content break based at least on the auxiliary media content information.
